(19) United States
(12) Patent Application Publication
(10) Pub. No.: US 2025/0242263 A1
(43) Pub. Date: Jul. 31, 2025

(54) STORAGE MEDIUM, GAME SYSTEM, GAME APPARATUS, AND GAME PROCESSING METHOD

(71) Applicant: Nintendo Co., Ltd., Kyoto (JP)

(72) Inventor: Tatsuya KURIHARA, Kyoto (JP)

(21) Appl. No.: 19/005,136

(22) Filed: Dec. 30, 2024

(30) Foreign Application Priority Data
Jan. 30, 2024 (JP) 2024-011598

(51) Int. Cl. A63F 13/69; A63F 13/52

(52) U.S. Cl. CPC A63F 13/69; A63F 13/52; A63F 2300/66

(57) ABSTRACT

According to a first instruction based on an operation input, voxel data is updated such that a density of a voxel included in a first range set at a location based on a location of a player character indicates the absence of a terrain. According to a second instruction based on an operation input, a density in the voxel data of a voxel included in a second range set at a location based on an operation input is updated such that a surface shape of a terrain approaches a plane set based on the location of the player character.

### CROSS REFERENCE TO RELATED APPLICATIONS

This application claims priority to Japanese Patent Application No. 2024-011598, filed on Jan. 30, 2024, the entire contents of which are incorporated herein by reference.

### FIELD

The technology disclosed herein relates to storage media, game systems, game apparatuses, and game processing methods that are capable of executing a process of generating an image using voxel data.

### BACKGROUND AND SUMMARY

There is a conventional image generation system that displays a game image by creating character voxels based on imaging information and generating polygon mesh information.

However, in such an image generation system, voxels are used in a game in order to use imaging information, and an object or the like generated from the voxels is not supposed to be freely deformed.

With the above in mind, the present example discloses a storage medium, game system, game apparatus, and game processing method that are capable of, for example, breaking and flattening an object generated from voxels, according to the user's operation, and thereby attaining deformation with a high degree of freedom in a game.

The present example may have the following features, for example.

An example configuration of a non-transitory computer-readable storage medium having stored therein a game program according to the present example is executed by one or more processors of an information processing apparatus. The game program causes the one or more processors to execute information processing comprising: storing, in a storage medium, volume data holding voxel data for each voxel included in a voxel space in a virtual space, the voxel data including at least a density indicating a degree to which a space defined by the voxel is occupied by an object, and thereby representing a shape of a terrain in the virtual space; moving a player character on the terrain, based on a user's operation input; causing the player character to perform a breaking action of breaking the terrain according to a first instruction based on the operation input, and when the breaking action hits the terrain, updating the voxel data such that the density of a voxel included in a first range set at a location based on a location of the player character indicates the absence of the terrain; causing the player character to perform a flattening action of flattening the terrain according to a second instruction based on the operation input, and according to the flattening action, updating the density in the voxel data of a voxel included in a second range set at a location based on the location of the player character such that a surface shape of the terrain approaches a plane set based on the location of the player character; and generating an image of the virtual space by rendering at least a polygon mesh representing a surface of the terrain, based on the terrain volume data.

Thus, a terrain generated from voxels can be freely broken according to the user's operation, and can also be flattened and regraded, and therefore, can be deformed with a high degree of freedom.

The information processing may further comprise: according to the flattening action, increasing the density of a voxel that is included on one direction side of the plane and has a density greater than or equal to a reference value, and increasing the density of a voxel whose density is smaller than the reference value, and for which the density of an adjacent voxel adjacent thereto on the one direction side or a density obtained by interpolating between the densities of a plurality of adjacent voxels is greater than or equal to the reference value, and decreasing the density of a voxel that is included on the other direction side of the plane and has a density smaller than the reference value, and decreasing the density of a voxel whose density is greater than or equal to the reference value, and for which the density of an adjacent voxel adjacent thereto on the other direction side or a density obtained by interpolating between the densities of a plurality of adjacent voxels is smaller than the reference value.

Thus, a feature of a terrain can be prevented from being lost when a ground surface is flattened.

The one direction may be opposite to a direction pointed by a normal vector to the plane, and the other direction is the direction pointed by the normal vector to the plane.

Thus, the flattening process can be easily executed using a normal vector to a plane.

The one direction may be a downward direction with respect to the virtual space, and the other direction may be an upward direction with respect to the virtual space.

Thus, the flattening process can be executed in which a plane can be approached by expansion below the plane and shrinkage above the plane.

The plane may be a horizontal plane in the virtual space.

Thus, a terrain can be flattened to be horizontal in a virtual space.

The plane may pass through a location where the player character is in contact with the terrain.

Thus, flattening can be attained in which a location of a player character is approached.

The plane may be sloped according to a slope of the terrain at a location of the player character.

Thus, flattening can be performed according to a slope of a terrain at a location of a player character.

The information processing may further comprise: displaying a scene that a surface of the terrain is shaken, by changing locations of vertices of the polygon mesh for a period of time, according to the flattening action.

Thus, flattening is performed while a scene that a surface of a terrain is shaken is displayed, so that changes in the terrain can be prevented from seeming unnatural to the user.

The voxel data may include data indicating a hardness or property of an object in the space defined by the voxel. The information processing may further comprise: updating the density of a voxel that is in the second range and whose hardness or property satisfies a condition, based on the flattening action.

Thus, flattening can be performed according to a hardness or property of an object.

The information processing may further comprise: generating the polygon mesh between a voxel defined in the terrain and a voxel defined out of the terrain, based on the density, according to an algorithm that determines locations of vertices of a polygon, based on the voxel data; and recalculating vertices of the polygon mesh in a range including at least a voxel whose voxel data has been updated, based on occurrence of the breaking action or the flattening action.

Thus, the recalculation of the vertices of a polygon mesh is limited to a range including voxels whose voxel data has been updated, resulting in a reduction in processing load.

The present example may be carried out in the form of a game system, game apparatus, and game processing method.

According to the present example, a terrain object generated from voxels can be freely broken according to the user's operation, and a terrain around a player character can be flattened and regraded, and can be deformed with a high degree of freedom in a game.

These and other features, aspects and advantages of the subject matter described herein will become more apparent from the following detailed description of the present exemplary embodiment when taken in conjunction with the accompanying drawings.

### BRIEF DESCRIPTION OF THE DRAWINGS

FIG. 1 is a diagram illustrating a non-limiting example of a state where a left controller 3 and a right controller 4 are attached to a main body apparatus 2,

FIG. 2 is a diagram illustrating a non-limiting example of a state where a left controller 3 and a right controller 4 are detached from a main body apparatus 2,

FIG. 3 illustrates six orthogonal views of a non-limiting example of a main body apparatus 2,

FIG. 4 illustrates six orthogonal views of a non-limiting example of a left controller 3,

FIG. 5 illustrates six orthogonal views of a non-limiting example of a right controller 4,

FIG. 6 is a block diagram illustrating a non-limiting example of an internal configuration of a main body apparatus 2,

FIG. 7 is a block diagram illustrating non-limiting examples of internal configurations of a main body apparatus 2, a left controller 3, and a right controller 4,

FIG. 8 is a view showing a non-limiting example of a terrain object, which is a voxel object,

FIG. 9 is a view showing a non-limiting example before removal of a portion of the terrain object shown in FIG. 8,

FIG. 10 is a view showing a non-limiting example after removal of a portion of the terrain object shown in FIG. 8,

FIG. 11 is a diagram showing a non-limiting example of content of voxel data,

FIG. 12 is a diagram showing a non-limiting example of property information representing properties of materials,

FIG. 13 is a diagram showing a non-limiting example of texture information representing textures of materials,

FIG. 14 is a diagram showing a non-limiting example of a method for generating a mesh,

FIG. 15 is a diagram showing a non-limiting example of a game image including a terrain object,

FIG. 16 is a diagram showing a non-limiting example of a game image in which a player character PC performs an action of breaking a terrain object TO displayed on a display 12,

FIG. 17 is a diagram showing a non-limiting example of a game image in which a player character PC has broken a terrain object TO,

FIG. 18 is a diagram showing a non-limiting example of a game image displayed on a display 12 in which a player character PC performs an action of flattening a terrain object TO,

FIG. 19 is a diagram showing a non-limiting example of a game image in which a player character PC has flattened a terrain object TO,

FIG. 20 is a diagram showing a non-limiting example of a destruction range of voxels to be broken in a terrain object TO according to a breaking action,

FIG. 21 is a diagram showing a non-limiting example of a flattening range and a target plane,

FIG. 22 is a diagram showing a non-limiting example of various kinds of data used in an information process executed in a game system 1,

FIG. 23 is a flowchart showing a non-limiting example of a flow of a game process that is executed in a game system 1,

FIG. 24 is a subroutine showing a non-limiting example of a flattening process of step S9 in the flowchart of FIG. 23, and

FIG. 25 is a subroutine showing a non-limiting example of a shaking process of step S11 in the flowchart of FIG. 23.

### DETAILED DESCRIPTION OF NON-LIMITING EXAMPLE EMBODIMENTS

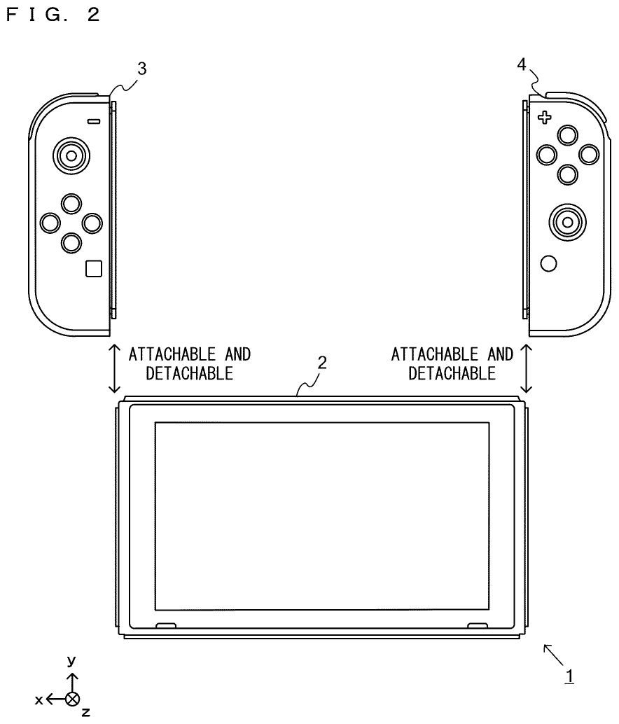

A game system according to the present embodiment will now be described. A non-limiting example of a game system 1 according to the present embodiment includes a main body apparatus (information processing apparatus serving as the main body of a game apparatus in the present embodiment) 2, a left controller 3, and a right controller 4. The left controller 3 and the right controller 4 are attachable to and detachable from the main body apparatus 2. That is, the user can attach the left controller 3 and the right controller 4 to the main body apparatus 2, and use them as a unified apparatus. The user can also use the main body apparatus 2 and the left controller 3 and the right controller 4 separately from each other (see FIG. 2). In the description that follows, a hardware configuration of the game system 1 of the present embodiment is described, and thereafter, the control of the game system 1 of the present embodiment is described.

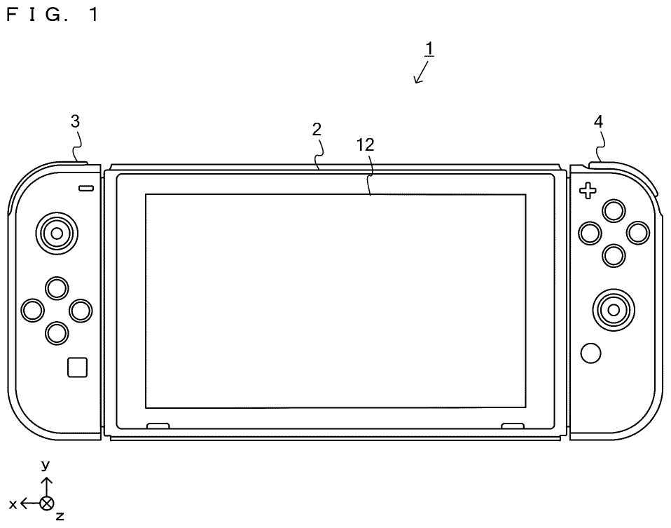

FIG. 1 is a diagram illustrating a non-limiting example of the state where the left controller 3 and the right controller 4 are attached to the main body apparatus 2. As illustrated in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram illustrating a non-limiting example of the state where each of the left controller 3 and the right controller 4 is detached from the main body apparatus 2. As illustrated in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

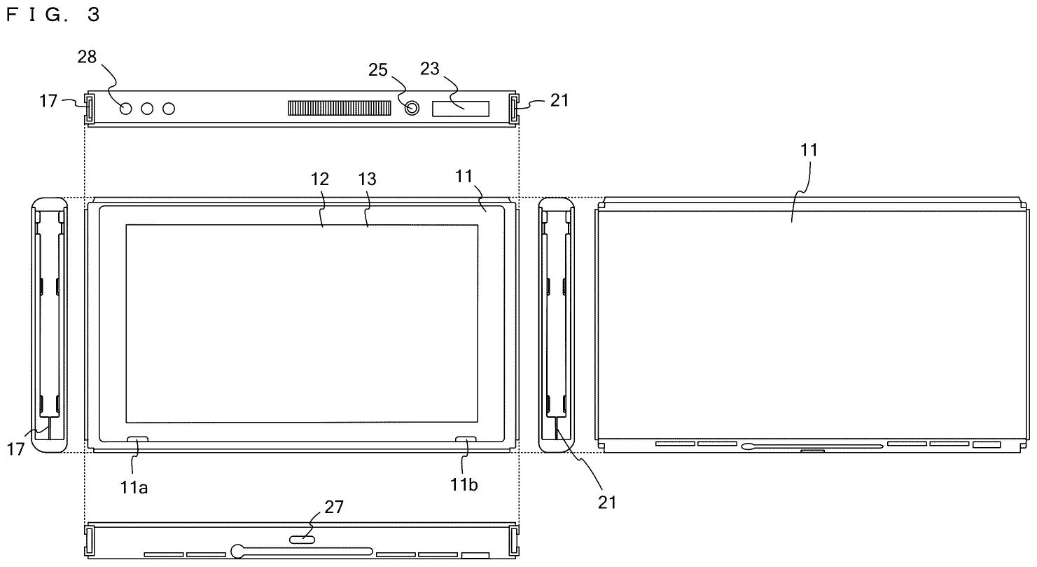

FIG. 3 illustrates six orthogonal views of a non-limiting example of the main body apparatus 2. As illustrated in FIG. 3, the main body apparatus 2 includes an approximately plate-shaped housing 11. In the present embodiment, a main surface (e.g., a surface on a front side, such as a surface on which the display 12 is provided) of the housing 11 has a generally rectangular shape.

It should be noted that the shape and the size of the housing 11 are optional. As a non-limiting example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As illustrated in FIG. 3, the main body apparatus 2 includes the display 12, which is provided on the main surface of the housing 11. The display 12 displays an image generated by the main body apparatus 2. In the present embodiment, the display 12 is a liquid crystal display device (LCD). The display 12, however, may be a display device of any suitable type.

In addition, the main body apparatus 2 includes a touch panel 13 on the screen of the display 12. In the present embodiment, the touch panel 13 allows multi-touch input (e.g., a capacitive touch panel). It should be noted that the touch panel 13 may be of any suitable type, e.g., it allows single-touch input (e.g., a resistive touch panel).

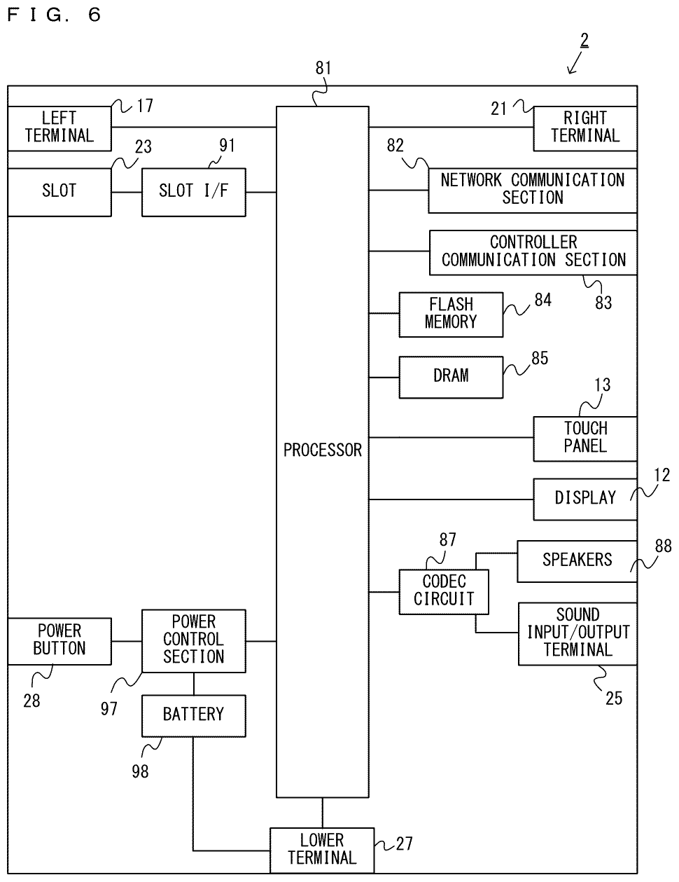

The main body apparatus 2 includes a speaker (e.g., a speaker 88 illustrated in FIG. 6) inside the housing 11. As illustrated in FIG. 3, speaker holes 11a and 11b are formed in the main surface of the housing 11. The speaker 88 outputs sounds through the speaker holes 11a and 11b.

The main body apparatus 2 also includes a left-side terminal 17 that enables wired communication between the main body apparatus 2 and the left controller 3, and a right-side terminal 21 that enables wired communication between the main body apparatus 2 and the right controller 4.

As illustrated in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower-side terminal 27. The lower-side terminal 27 allows the main body apparatus 2 to communicate with a cradle. In the present embodiment, the lower-side terminal 27 is a USB connector (more specifically, a female connector). When the unified apparatus or the main body apparatus 2 alone is placed on the cradle, the game system I can display, on a monitor, an image that is generated and output by the main body apparatus 2. The monitor may be stationary or may be movable. Also, in the present embodiment, the cradle has the function of charging the unified apparatus or the main body apparatus 2 alone, being placed thereon. The cradle also functions as a hub device (specifically, a USB hub).

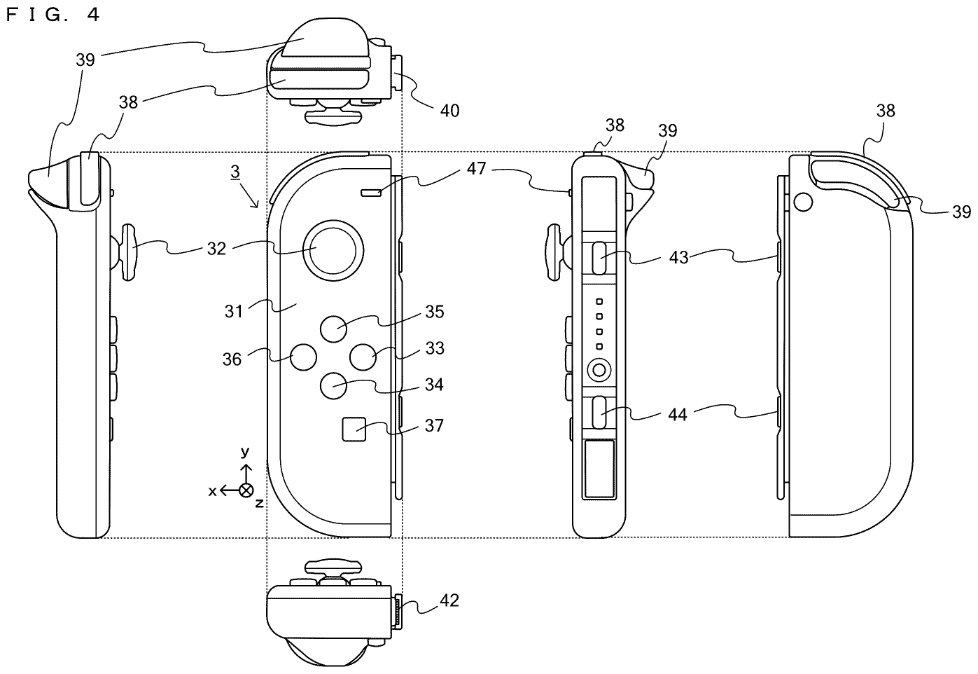

FIG. 4 illustrates six orthogonal views of a non-limiting example of the left controller 3. As illustrated in FIG. 4, the left controller 3 includes a housing 31. In the present embodiment, the housing 31 has a vertically long shape. The housing 31 may be shaped to be long in an up-down direction, e.g., along the y-axis direction illustrated in FIGS. 1 and 4. In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As illustrated in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the present embodiment, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an operating system (OS) program and an application program) executed by the main body apparatus 2.

The left controller 3 also includes a terminal 42 that enables wired communication between the left controller 3 and the main body apparatus 2.

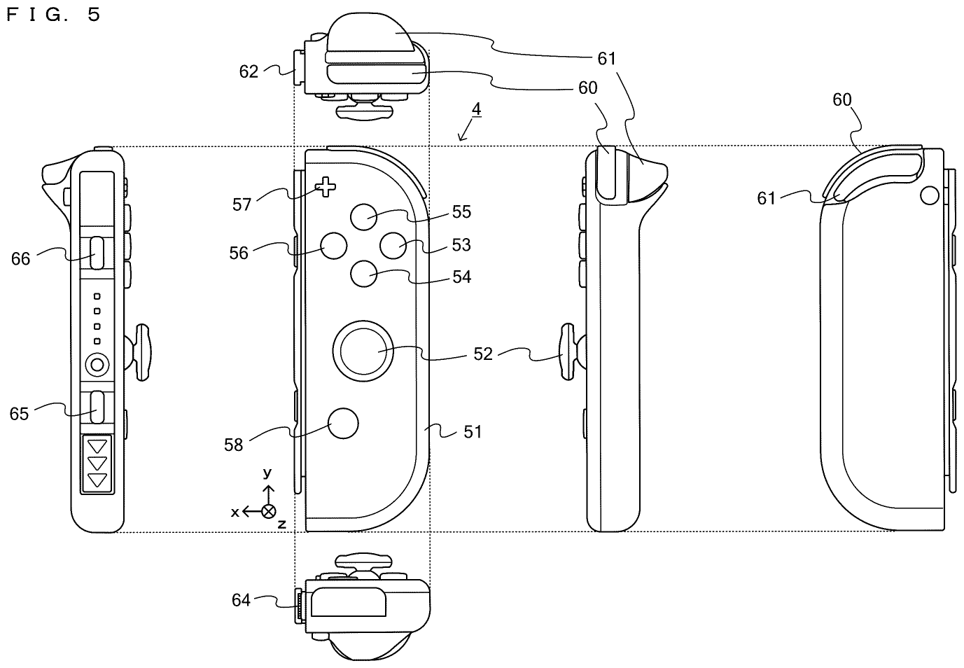

FIG. 5 illustrates six orthogonal views of a non-limiting example of the right controller 4. As illustrated in FIG. 5, the right controller 4 includes a housing 51. In the present embodiment, the housing 51 has a vertically long shape. For example, the housing 51 may be shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the present embodiment, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for allowing the right controller 4 to perform wired communication with the main body apparatus 2.

FIG. 6 is a block diagram illustrating a non-limiting example of an internal configuration of the main body apparatus 2. The main body apparatus 2 includes components 81 to 91, 97, and 98 illustrated in FIG. 6 in addition to the components illustrated in FIG. 3. Some of the components 81 to 91, 97, and 98 may be implemented as electronic parts on an electronic circuit board, which is contained in the housing 11.

The main body apparatus 2 includes a processor 81. The processor 81 is an information processor for executing various types of information processing to be executed by the main body apparatus 2. For example, the CPU 81 may include only a central processing unit (CPU), or may be a system-on-a-chip (SoC) having a plurality of functions such as a CPU function and a graphics processing unit (GPU) function. The processor 81 executes an information processing program (e.g., a game program) or other instructions that are stored in storage (e.g., an internal non-transitory storage medium such as a flash memory 84, an external non-transitory storage medium that is attached to the slot 23, or the like), thereby executing the various types of information processing.

The main body apparatus 2 includes a flash memory 84 and a dynamic random access memory (DRAM) 85 as examples of internal storage media built in itself. The flash memory 84 and the DRAM 85 are connected to the CPU 81. The flash memory 84 is mainly used to store various data (or programs) to be saved in the main body apparatus 2. The DRAM 85 is used to temporarily store various data used in information processing. The DRAM 85 and the flash memory 84 are illustrative non-limiting examples of non-transitory computer-readable media.

The main body apparatus 2 includes a slot interface (hereinafter abbreviated to “I/F”) 91. The slot I/F 91 is connected to the processor 81. The slot I/F 91 is connected to the slot 23, and reads and writes data from and to a predetermined type of storage medium (e.g., a dedicated memory card) attached to the slot 23, in accordance with commands from the processor 81.

The processor 81 reads and writes, as appropriate, data from and to the flash memory 84, the DRAM 85, and each of the above storage media, thereby executing the above information processing.

The main body apparatus 2 includes a network communication section 82. The network communication section 82 is connected to the processor 81. The network communication section 82 communicates (specifically, through wireless communication) with an external apparatus via a network. In the present embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a particular protocol or infrared light communication). It should be noted that the wireless communication in the above second communication form achieves the function of allowing so-called “local communication”, in which the main body apparatus 2 can wirelessly communicate with another main body apparatus 2 located in a closed local network area, and the plurality of main body apparatuses 2 directly communicate with each other to exchange data.

The main body apparatus 2 includes a controller communication section 83. The controller communication section 83 is connected to the processor 81. The controller communication section 83 wirelessly communicates with the left controller 3 and/or the right controller 4. The main body apparatus 2 may communicate with the left and right controllers 3 and 4 using any suitable communication method. In the present embodiment, the controller communication section 83 performs communication with the left and right controllers 3 and 4 in accordance with the Bluetooth (registered trademark) standard.

The processor 81 is connected to the left-side terminal 17, the right-side terminal 21, and the lower-side terminal 27. When performing wired communication with the left controller 3, the processor 81 transmits data to the left controller 3 via the left-side terminal 17 and also receives operation data from the left controller 3 via the left-side terminal 17. Further, when performing wired communication with the right controller 4, the processor 81 transmits data to the right controller 4 via the right-side terminal 21 and also receives operation data from the right controller 4 via the right-side terminal 21. Further, when communicating with the cradle, the processor 81 transmits data to the cradle via the lower-side terminal 27. As described above, in the present embodiment, the main body apparatus 2 can perform both wired communication and wireless communication with each of the left and right controllers 3 and 4. Further, when the unified apparatus obtained by attaching the left and right controllers 3 and 4 to the main body apparatus 2 or the main body apparatus 2 alone is attached to the cradle, the main body apparatus 2 can output data (e.g., image data or sound data) to a stationary monitor or the like via the cradle.

Here, the main body apparatus 2 can communicate with a plurality of left controllers 3 simultaneously (or in parallel). Further, the main body apparatus 2 can communicate with a plurality of right controllers 4 simultaneously (or in parallel). Thus, a plurality of users can simultaneously provide inputs to the main body apparatus 2, each using a set of left and right controllers 3 and 4. As a non-limiting example, a first user can provide an input to the main body apparatus 2 using a first set of left and right controllers 3 and 4, and at the same time, a second user can provide an input to the main body apparatus 2 using a second set of left and right controllers 3 and 4.

Further, the display 12 is connected to the processor 81. The processor 81 displays, on the display 12, a generated image (e.g., an image generated by executing the above information processing) and/or an externally obtained image.

The main body apparatus 2 includes a codec circuit 87 and speakers (specifically, a left speaker and a right speaker) 88. The codec circuit 87 is connected to the speakers 88 and an audio input/output terminal 25 and also connected to the processor 81. The codec circuit 87 is for controlling the input and output of audio data to and from the speakers 88 and the sound input/output terminal 25.

The main body apparatus 2 includes a power control section 97 and a battery 98. The power control section 97 is connected to the battery 98 and the processor 81. Further, although not illustrated, the power control section 97 is connected to components of the main body apparatus 2 (specifically, components that receive power supplied from the battery 98, the left-side terminal 17, and the right-side terminal 21). Based on a command from the processor 81, the power control section 97 controls the supply of power from the battery 98 to each of the above components.

Further, the battery 98 is connected to the lower-side terminal 27. When an external charging device (e.g., the cradle) is connected to the lower-side terminal 27, and power is supplied to the main body apparatus 2 via the lower-side terminal 27, the battery 98 is charged with the supplied power.

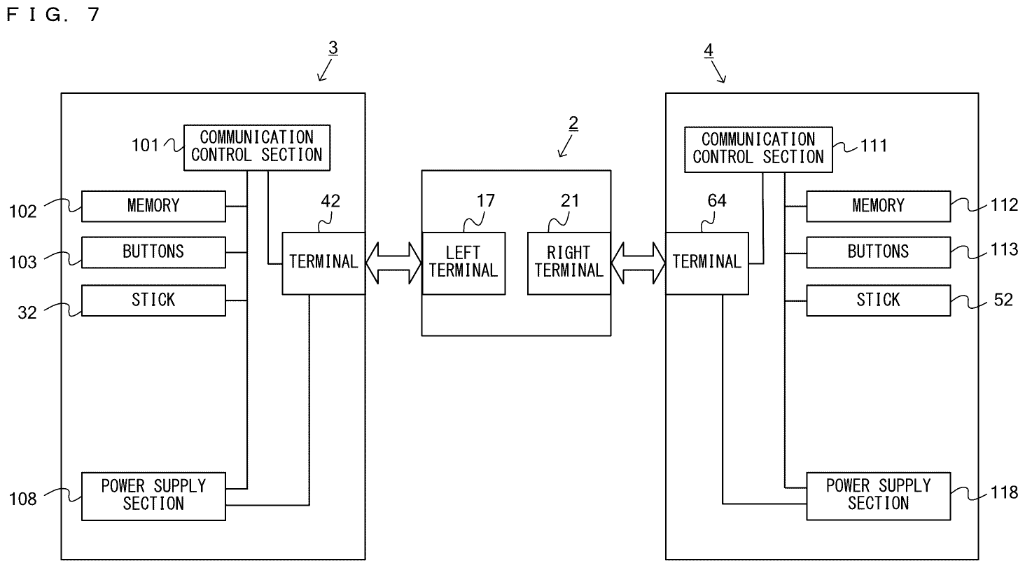

FIG. 7 is a block diagram illustrating non-limiting examples of the internal configurations of the main body apparatus 2, the left controller 3, and the right controller 4. It should be noted that the details of the internal configuration of the main body apparatus 2 are illustrated in FIG. 6 and therefore are omitted in FIG. 7.

The left controller 3 includes a communication control section 101, which communicates with the main body apparatus 2. As illustrated in FIG. 7, the communication control section 101 is connected to components including the terminal 42. In the present embodiment, the communication control section 101 can communicate with the main body apparatus 2 through both wired communication via the terminal 42 and wireless communication without via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation or the detection result of the sensor) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the present embodiment, the power supply section 108 includes a battery and a power control circuit. Although not illustrated in FIG. 7, the power control circuit is connected to the battery and also connected to components of the left controller 3 (specifically, components that receive power supplied from the battery).

As illustrated in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, a communication control section 111 can communicate with the main body apparatus 2 through both wired communication via the terminal 64 and wireless communication without via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

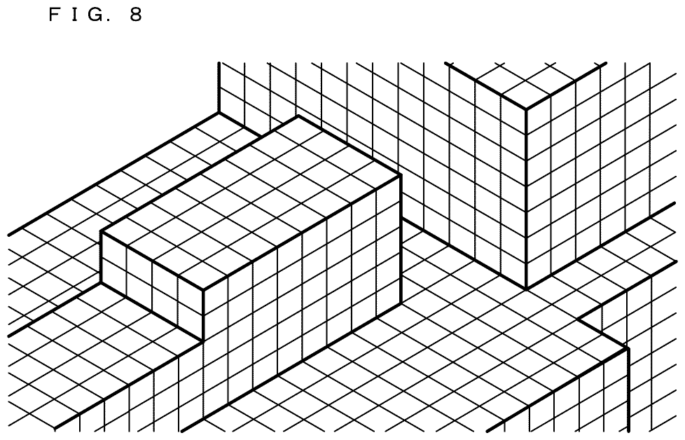

Next, referring to FIG. 8 to FIG. 15, an outline of the process performed on the game system 1 will be described. In the present embodiment, the game system 1 generates a game image in which terrain objects and characters (e.g., a player character that is controlled by the user) are arranged in a game space, which is a three-dimensional virtual space, and displays the game image on a display device. Note that in the present embodiment, the display device on which the game image is displayed may be the display 12 described above, or may be a stationary monitor.

In the present embodiment, for some objects in the game space, the shape is defined by voxel data. Here, voxels are rectangular parallelepiped (more specifically, cubic) regions arranged in a grid pattern in the game space, and voxel data is data that is set for each voxel. Hereinafter, an object whose shape is defined by voxel data will be referred to as a “voxel object”. In the present embodiment, the game system 1 stores voxel data for each of a plurality of voxels that are set in the game space as data for generating voxel objects in the game space.

FIG. 8 is a view showing an example of a terrain object, which is a voxel object. As shown in FIG. 8, in the present embodiment, a terrain object representing a terrain such as a ground surface has its shape defined by voxel data. The cubes shown in FIG. 8 represent a terrain object. Note that in FIG. 8, edges of the terrain object are indicated by thick lines. However, the thick lines are added for the purpose of making the drawings easier to understand, and there is actually no need for edges of the terrain object to be drawn thick.

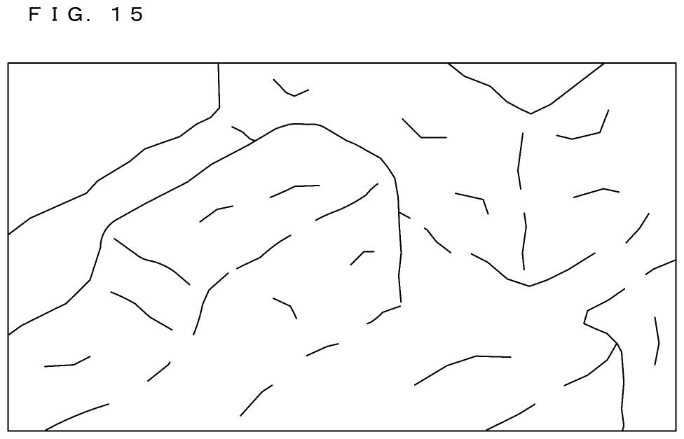

For example, the terrain object shown in FIG. 8 is generated by the following rule: “a cube is placed at the position of a voxel if a parameter included in the voxel data set for the voxel is greater than a predetermined value, and nothing is placed at the position of the voxel if the parameter is smaller than or equal to the predetermined value”. The terrain object shown in FIG. 8 is shown for the purpose of illustrating the relationship between voxels and voxel objects in an easy-to-understand manner. Note however that in the present embodiment, in practice, a voxel object is generated by such a rule (e.g., based on the voxel data) that results in a terrain object having a complicated shape in comparison with the cubic voxels, such as a terrain object shown in FIG. 15 to be described below, for example. Note that there is no limitation on the rule for determining the shape of the voxel object based on the voxel data. In other embodiments, the game system 1 may generate a voxel object as shown in FIG. 8 based on the object data or may generate a voxel object as shown in FIG. 15 based on the object data.

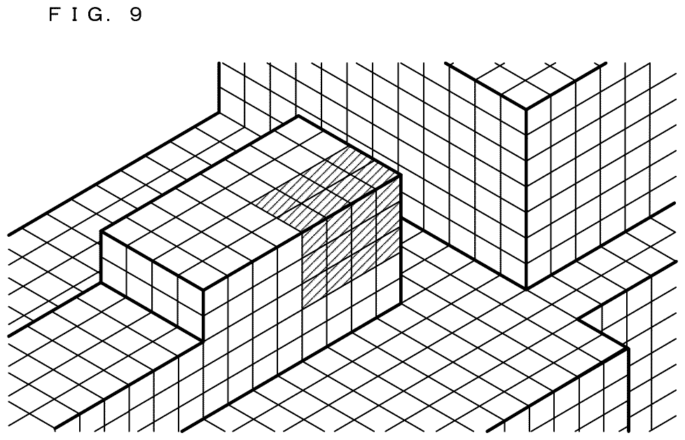

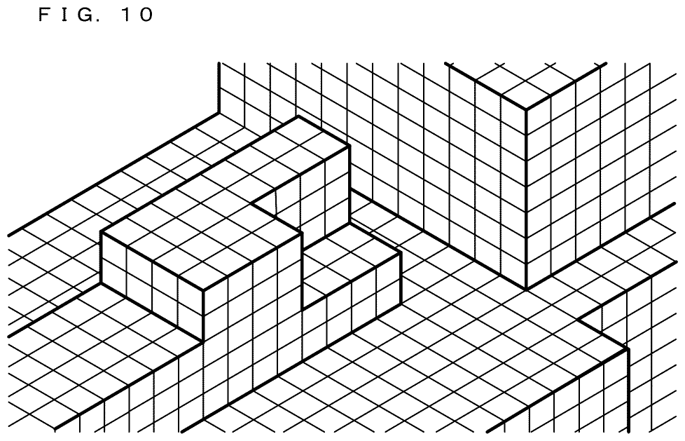

It is possible to change the shape of a voxel object by changing voxel data of voxels. FIG. 9 and FIG. 10 are views showing before and after the removal of a portion of the terrain object shown in FIG. 8. That is, when the hatched portion of the terrain object shown in FIG. 9 is broken, the terrain object changes to a shape as shown in FIG. 10. In such a case, the game system 1 can easily delete the terrain object by rewriting voxel data to be described below so as to indicate that the terrain object is absent for voxels in the hatched portion. Note that also when making an addition to the terrain object, as when deleting the terrain object, the game system 1 can easily change the shape of the terrain object by changing the voxel data of voxels.

Thus, the game system I can freely change the shape of a voxel object by rewriting the voxel data. For example, when the shape of a terrain object may be changed as a result of the terrain object in a game being broken for some reason (e.g., the player character striking the terrain object), the game system 1 can freely change the shape of the terrain object by changing the voxel data used to generate the terrain object, rather than directly changing data representing the outer shape of the terrain object (e.g., the mesh to be described below).

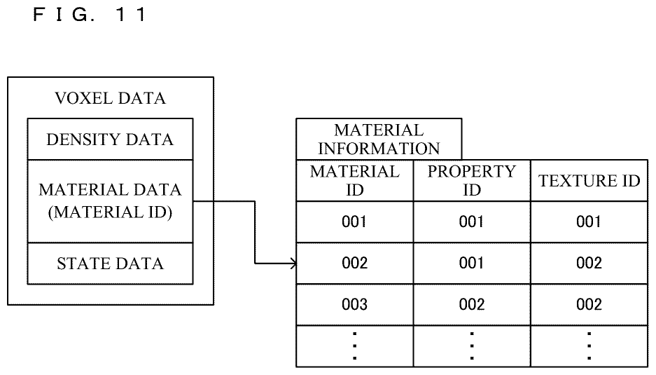

FIG. 11 is a diagram showing an example of content of voxel data. Here, in the present embodiment, the game space can be divided into a plurality of voxels arranged in a grid pattern. The game system 1 stores voxel data for each voxel in the game space so that the voxel data is associated with the voxel. The voxel data represents, for example, the presence/absence of a voxel object in the voxel corresponding to the voxel data.

As shown in FIG. 11, voxel data includes density data. The density data represents a density that indicates the degree to which an object is included in a region defined by each voxel. As will be described in detail below, the position and the shape of the surface of the voxel object (e.g., the mesh to be described below) are determined based on this density. In other words, in the present embodiment, this density is also data that is used to generate a mesh that defines the surface of the voxel object.

In the present embodiment, the density can take an integer value in the range from the lower limit value (e.g., 0) to the upper limit value (e.g., 255). In the present embodiment, in the game system 1, the proportion of the volume to be occupied by the voxel object in a voxel tends to be higher when the density value set for the voxel is higher, and the proportion in a voxel tends to be lower when the density value is lower. For example, if the density is 0, there is no voxel object in the voxel, if the density is 255, the inside of the voxel is entirely the object, and if the density is between 0 and 255, the inside of the voxel is occupied by the object to the proportion that is determined based on the density value. Then, the shape of the voxel mesh, e.g., the shape of the voxel object, is determined based on the density. Note however that the shape of the voxel object generated based on the density does not need to have a volume that exactly matches the proportion represented by the density. For example, the method of generating a voxel object as shown in FIG. 8 and the method of generating a voxel object as shown in FIG. 15 may differ in the volume of the voxel object, even if they are based on the same density.

Note that in other embodiments, the density may indicate either a state in which the voxel object occupies the entirety of the region within the voxel or a state in which no voxel object is included in the region within the voxel. For example, the density data may be data that can take only one of 0 or 1.

As shown in FIG. 11, voxel data includes material data. The material data represents the material (in other words, the substance) of the voxel object generated by the voxel data. Here, in the present embodiment, materials such as sand, rock and soil, for example, are set for voxel objects. That is, in the present embodiment, a plurality of types of materials are provided as materials that can be set for a voxel object, and one of the materials is set for a voxel object.

As shown in FIG. 11, in the present embodiment, the material data represents the identification information of the material (referred to as “material ID”). In the present embodiment, the game system 1 stores material information representing the property and the texture of the material for each material provided in the game. In the present embodiment, the material information represents associations between the material ID, the property of the material and the appearance (specifically, the texture) of the material. Specifically, the material information is information that represents associations between the material ID, identification information of the property of the material (referred to as “property ID”) and identification information of the texture of the material (referred to as “texture ID”) (see FIG. 11).

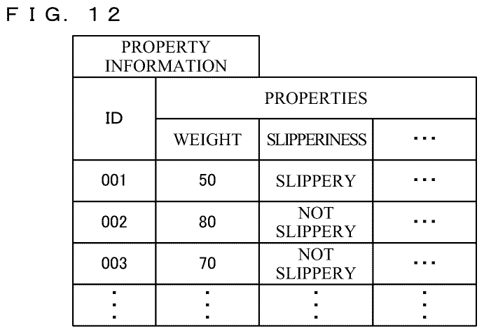

FIG. 12 is a diagram showing an example of property information representing properties of materials. As shown in FIG. 12, the game system 1 stores property information that associates each property ID with information that represents the content of the property represented by the property ID. A property of a material is a property of a voxel object for which the material is set in the game, and it may be information such as weight or slipperiness shown in FIG. 12, for example. Note that there is no limitation on the specific content of the property. For example, the following information may be set as properties of a material.
Temperature
Breakability (e.g., the number of times of impact impartation needed to break a voxel object)
Whether another object can be bonded to a voxel object
Amount of hit points to be regained by the player character when the player character breaks a voxel object
Amount of in-game currency to be gained by the player character when the player character breaks a voxel object

Note that there is no limitation on the specific content of the property to be set for a material. In other embodiments, information different from those listed above may be set as information that represents a property of a material.

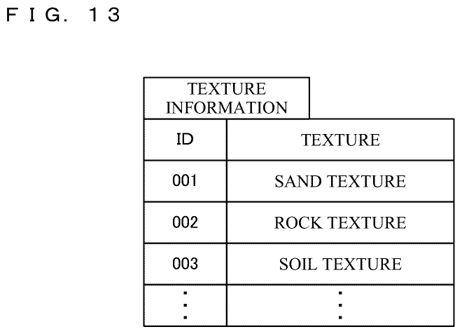

FIG. 13 is a diagram showing an example of texture information representing textures of materials. As shown in FIG. 13, the game system 1 stores texture information that associates the texture ID with the texture represented by the texture ID.

Note that in addition to information of texture, any information regarding the color and/or pattern may be set as data that defines the appearance of a voxel object. For example, a pattern of cracks may be set as information regarding the appearance of a voxel object. By using such a pattern, the game system 1 can generate an image of a voxel object that represents the appearance of cracks.

As described above, in the present embodiment, the material data defines, by the material ID, the property of the voxel object and the texture used for the voxel object. For example, when the material ID represented by the material data included in the voxel data is “002”,the property represented by the property ID “001” that is associated with the material ID in the material information is set as the property of the voxel object corresponding to the voxel data (see arrow shown in FIG. 11). In this case, the texture that is represented by the texture ID “002” associated with the material ID in the material information is applied to the voxel object corresponding to the voxel data (see arrow shown in FIG. 11).

As described above, in the present embodiment, the game system 1 separately manages the property and the texture of the material. Therefore, in the present embodiment, it is possible to easily set a plurality of types of materials having the same property but having different appearances (e.g., different textures) or set a plurality of types of materials having different properties but having the same appearance.

Note that the material data may be any data with which it is possible to identify the property and/or the texture of the material. For example, in other embodiments, the material data may represent the property ID and the texture ID, or may have a data structure that actually includes data representing the property and the texture of the material.

The material data may further represent information related to the material other than the property and the texture described above. For example, the material data may include special effect data that represents the special effect to be triggered upon satisfaction of a special effect triggering condition set for the voxel object (e.g., a portion of the voxel object being broken, or the character stepping on the voxel object). Note that the special effect data may be data that represents a special effect image (e.g., a special effect image showing the voxel object being broken), or may be data that represents a special effect sound (a sound of footstep when the character walks on the voxel object).

As shown in FIG. 11, the voxel data includes state data that represents the state of the voxel object. There is no limitation on the specific content of the state data. For example, the state data may be data that represents whether the voxel object is in a wet state, or may be data that represents the amount of damage to the voxel object. The content of the state data may be updated during the game.

In the present embodiment, the surface of the voxel object is represented by a mesh. A mesh is a set of faces (specifically, polygons) placed in the game space. In the present embodiment, the game system 1 generates a mesh for the voxel object based on the voxel data of each voxel set in the game space. An example of how a mesh is generated based on voxel data will now be described.

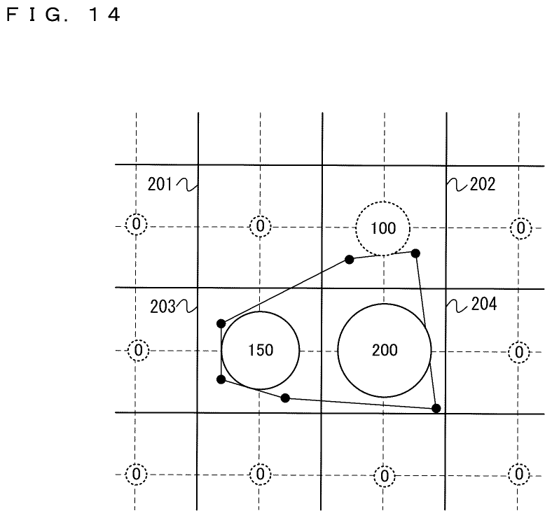

FIG. 14 is a diagram showing an example of a method for generating a mesh. Note that in FIG. 14, voxels and meshes are represented in two dimensions for the purpose of making the drawing easier to understand and for the sake of discussion, but in practice, a three-dimensional mesh is generated based on voxels in a three-dimensional space.

As described above, in the present embodiment, the density set for the voxel is in the range of 0 to 255. In the present embodiment, voxels with densities equal to or greater than the reference value are considered to be inside the voxel object, and voxels with densities smaller than the reference value are considered to be outside the voxel object. It is not necessary to define only voxels with a density of 0 as being outside the voxel object (e.g., reference value=1), and the reference value may be set to 128, for example. In the example shown in FIG. 14, a voxel 201 and the other outer voxels have a density of 0, a voxel 202 has a density of 100, which is smaller than the reference value, and voxels 203 and 204 have densities of 150 and 200, which are greater than the reference value. In the present embodiment, the game system 1 generates vertices between those voxels whose densities are equal to or greater than the reference value and those voxels whose densities are smaller than the reference value. Specifically, for each region (region delimited by dotted lines) that straddles eight (four in the figure) adjacent voxels, it is determined whether or not to generate a vertex. That is, a vertex is generated in each region that straddles both a voxel whose density is equal to or greater than the reference value and a voxel whose density is smaller than the reference value. Then, a polygon mesh is generated by connecting together adjacent vertices if the connection (the boundary between the regions including the vertices) passes through a voxel whose density is equal to or greater than the reference value and a voxel whose density is smaller than the reference value.

The coordinates of each vertex are determined by comparing densities of adjacent voxels and interpolating based on the difference in density for each of the XYZ axes. In this process, the coordinates can be further calculated based on the normal information. The normal information may be stored in advance for at least some of the voxels, or if not stored, the normal information may also be calculated based on densities between adjacent voxels. Note that in FIG. 14, the density of the voxel 202 is smaller than the reference value, the voxel 202 is treated as being outside the voxel object in the determination of the presence/absence of a vertex, but the density value itself of the voxel 202 is used to calculate the coordinates of the vertices generated. If the reference value were set to a value lower than the density of the voxel 202, it would result in an increase in the vertices on the upper right side and the upper left side in the voxel 202 of FIG. 14.

By generating a polygon mesh as described above, it is possible to generate a shape whose volume reflects the density of each voxel to some extent. Note however that depending on the relationship with neighboring voxels, it is possible that a voxel with a density of 0 may partially include a region inside the voxel object, or a voxel with a density of 255 may partially include a region outside the voxel object. Since voxels with densities smaller than the reference value are treated as being outside the voxel object in the present embodiment, there are fewer vertices as compared with a case where those voxels are treated as being inside the voxel object, the volume will be smaller accordingly. That is, there is no need to calculate the polygon mesh so that the volume strictly corresponds to the density value.

FIG. 15 shows an example of a game image including a terrain object. In the present embodiment, by generating a mesh as described above, the voxel object can be made in a shape with complicated irregularities compared to the cubic voxels, for example.

Note that there is no limitation on the method of generating a mesh based on voxel data. For example, in other embodiments, if the density of the voxel data is greater than a predetermined value, a mesh may be generated so that a cube is placed in the voxel (see FIG. 8).

For each face of the mesh generated as described above, the game system 1 determines the appearance (e.g., color and/or pattern) of each such face according to the material identified by the voxel data. Specifically, the game system 1 determines the texture to be used for rendering each face of the mesh based on the voxel data, and maps the determined texture to each face to generate an image of the voxel object. Note that the texture to be mapped to each face of the mesh is determined based on the voxel data of the voxel used to generate the face (which will be referred to as the target voxel) among the voxels where the voxel object exists. Note that the target voxel is, for example, one or more voxels located around the face, although it depends on the mesh generation method. That is, the texture mapped to a face of the mesh is determined to be a texture corresponding to the material set for one or more voxels placed around the face.

Note that in other embodiments, one voxel data may include multiple types (e.g., two types) of material data. In such a case, the voxel data includes ratio data related to the multiple types of material data. The ratio data is data for determining the texture to be used for the voxel object, and represents the ratio by which each of the materials (specifically, the texture corresponding to the material) represented by the multiple types of material data influences the appearance (specifically, the color and/or pattern) of the voxel object. When determining the texture to be mapped to each face of the mesh, the texture is determined based on various data (specifically, density data, multiple types of material data and ratio data) included in the voxel data of the target voxel. For example, when multiple types of materials are set for a target voxel corresponding to one face, a texture corresponding to the (one type of) material with the greatest degree of influence may be used while taking the ratio into consideration, or textures corresponding to multiple types of materials may be used while taking the ratio into consideration.

In other embodiments, there may be both voxel objects for which voxel data including one type of material data is used, and voxel objects for which voxel data including two types of material data is used.

As described above, in the present embodiment, the game system 1 sets the color and/or pattern of the mesh of the voxel object based on appearance data (specifically, a texture ID representing a texture) that defines the color and/or pattern of the voxel object for each voxel. Specifically, for a mesh to be generated based on voxel data of a certain voxel, among meshes of voxel objects, the game system 1 applies the texture represented by the appearance data for the voxel to the mesh of the voxel object that is generated based on the voxel data for the certain voxel. Thus, it is possible to set the color and/or pattern of the voxel object using the appearance data set for the voxel.

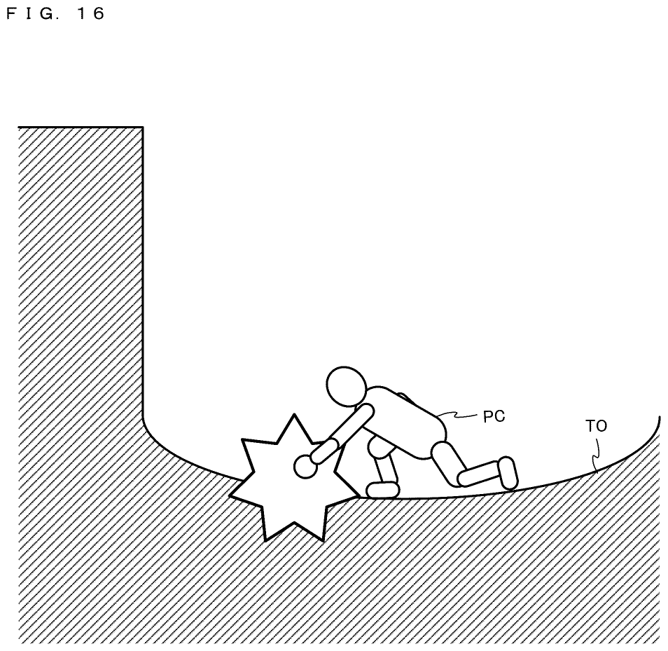

Next, an example of game play in which a player character is operated in a game space according to the user's operation performed on the game system 1 will be described with reference to FIGS. 16 to 21. For example, in the present example, a player character PC appearing in the game space displayed on the display 12 is operated according to the user's operation performed on the operation buttons and sticks of the left controller 3 and/or the right controller 4 of the game system 1 in the unified form, the user's touch operation performed on the touch panel 13 of the main body apparatus 2, the user's operation of moving the entire game system 1 or changing the orientation of the game system 1, and the like.

FIG. 16 is a diagram showing an example of a game image in which the player character PC performs an action of breaking a terrain object TO displayed on the display 12, and is a cross-sectional view of the terrain object TO. In FIG. 16, the player character PC is performing a breaking action such as punching a terrain object TO provided on a game field according to the user's operation. Here, the terrain object TO is an example of a voxel object that is generated based on the above voxel data, and a surface of which is represented by a mesh. In the example of FIG. 16, a voxel space in which voxels are specified is set on the game field in the game space, and the terrain object TO is generated on the game field by a plurality of voxels specified in the voxel space. Here, at least one voxel space is set in at least a portion of the game space in order to specify a plurality of voxels. For each voxel space, the length (resolution) of an edge of a voxel, the vectors (orientations) of the x-, y-, and z-axes of a global coordinate system in a vector space, the length of the voxel space in each of the x-, y-, and z-directions, and a location of the voxel space in the game space, and the like are specified. Although FIGS. 16 to 19 show an example of a cross-section of the terrain object TO rendered by generation of a mesh having an appearance as shown in FIG. 15 using the technique described with reference to FIG. 14, the terrain object TO may be rendered using a block-shaped mesh as described in FIG. 9 or 10.

In the present example, at least a portion of the terrain object TO can be broken to disappear by the player character PC performing an action of breaking the terrain object TO. As an example, as shown in FIG. 16, the terrain object TO can be broken such that the terrain object TO is partially deformed, so that a portion thereof disappears, by the player character PC performing an action of hitting a portion of the terrain object TO. Note that in the example of FIG. 16, the terrain object TO has a ground portion that is in the shape of a dish that is curved downward in the middle, and a wall portion that is located to the left of the ground and rises up in the game space. The player character PC is located at substantially the center of the ground portion, and is performing a breaking action of breaking a portion of the ground portion.

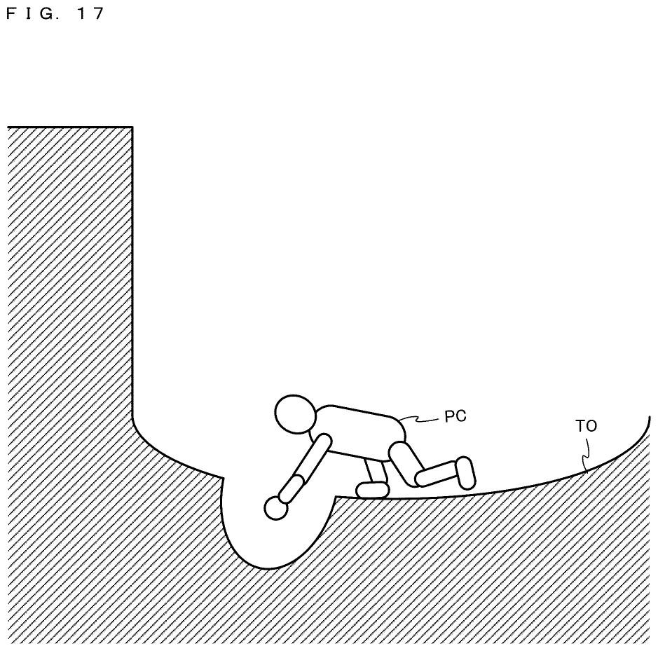

FIG. 17 is a diagram showing an example of a game image showing a broken state of the terrain object TO after the player character PC has broken the terrain object TO, and is a cross-sectional view showing the terrain object TO. As shown in FIG. 17, a portion of the terrain object TO is broken and deformed by the player character PC's breaking action, and is removed from the game space. As an example, in the terrain object TO of FIG. 17, a semi-ellipsoidal destruction range has been formed by the player character PC's breaking action. Due to the breaking action, a downward hole has been dug by removal of a portion of the dish-shaped ground portion of the terrain object TO, so that the terrain object TO has a rougher ground portion than before the breaking action. In the present example, even when such a significantly rough ground portion has been formed in the terrain object TO due to the player character PC's breaking action, the ground portion can be deformed and flattened according to the user's operation. Note that the above destruction range corresponds to an example of a first range set at a location based on a location of a player character.

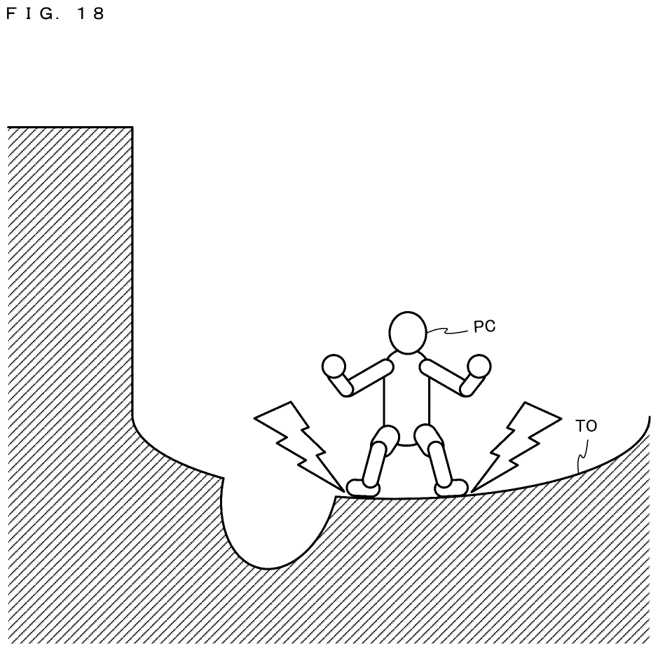

FIG. 18 is a diagram showing an example of a game image displayed on the display 12 in which the player character PC performs an action of flattening the terrain object TO, and is a cross-sectional view of the terrain object TO. In FIG. 18, the player character PC is performing a flattening action of flattening the terrain object TO, on which the player character PC is located, according to the user's operation.

In the present example, at least a portion of the terrain object TO can be flattened by the player character PC performing an action of flattening the terrain object TO. As an example, a portion of the terrain object TO can be deformed and flattened by the player character PC slapping a portion of the terrain object TO, performing an action of jumping and landing on the terrain object TO, or the like. Note that in the example of FIG. 18, the ground portion of the terrain object TO is in the shape of a dish that is curved downward in the middle, and a hole is formed in a portion of the ground portion. The player character PC, which is located near a center of the ground portion, is performing a flattening action of flattening the ground portion.

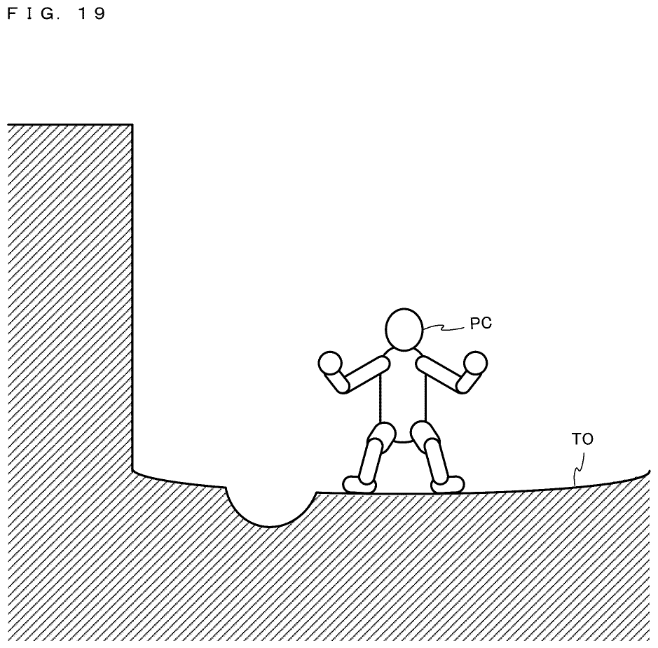

FIG. 19 is a diagram showing an example of a game image in which the player character PC has flattened the terrain object TO, and is a cross-sectional view of the terrain object TO. As shown in FIG. 19, the ground of the terrain object TO has been partially flattened and deformed by the player character PC's flattening action. As an example, the ground portion of the terrain object TO of FIG. 19 is deformed such that the shape of a surface in a flattening range set at a location based on a location of the player character PC performing a flattening action approaches a target plane. Specifically, as can be seen by comparison between the cross-sectional view of the terrain object TO of FIG. 18 and the cross-sectional view of the terrain object TO of FIG. 19, the terrain object TO is deformed such that an outer peripheral portion of the dish-shaped ground portion which is higher than the location of the player character PC is lowered. Meanwhile, the terrain object TO is deformed such that in the ground portion, the depth of the hole, which is lower than the location of the player character PC, becomes shallow, e.g., the bottom of the hole is raised. Note that the flattening range corresponds to an example of a second range set at a location based on a location of a player character.

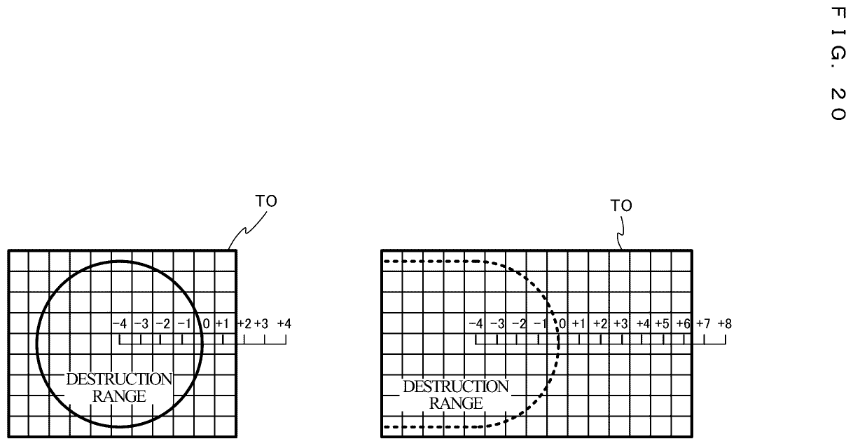

In the present example, by changing the voxel data of the voxels constituting the terrain object TO, the process of how the terrain object TO is broken and deformed/removed or is flattened can be represented. FIG. 20 is a diagram showing an example of a destruction range of voxels to be broken in a terrain object TO according to a breaking action. Note that the left figure of FIG. 20 shows a front surface (surface to be broken) of the terrain object TO as viewed from the player character PC, which breaks the terrain object TO. The right figure of FIG. 20 shows a side surface of the terrain object TO shown in the left figure.

The destruction range of the terrain object TO to be broken by the player character PC's breaking action is set based on the location where the player character PC breaks the terrain object TO, the player character PC's strength and capability, and the strength (material) of the terrain object TO. For example, the destruction range is set such that a distance from a reference location set based on a location where the player character PC has performed a breaking action in the game space is within a predetermined distance. In the example of FIG. 20, for the terrain object TO, a bell-shaped destruction range having a semi-spherical shape at a deepest portion lost due to the destruction is formed around the location where the player character PC has performed a breaking action. Note that the shape of the destruction range may be other shapes such as a sphere, ellipsoid, cube, cylinder, wedge, shapes generated by 3D software, and in addition, these shapes a portion of which has been removed, and the like. The destruction range may be located around a location where the player character PC has performed a breaking action (e.g., a location where the player character PC's punching fist has reached) in the game space, or around a location at a predetermined distance in front of said location as viewed from the player character PC.

The above destruction range is represented by a signed distance field (SDF), and a voxel to be removed/deformed is determined using a signed distance. In the case in which the destruction range is represented by an SDF, a distance between each voxel and a surface of the destruction range closest to that voxel is determined using a signed distance. Specifically, it is assumed that the signed distance of a voxel located on a surface of the destruction range is zero, the signed distance of a voxel located outside the destruction range is positive, and the signed distance of a voxel located inside the destruction range is negative. A removal/deformation process is set for each voxel, depending on the signed distance of the voxel. For example, for a voxel to be removed, a portion of the terrain object TO that corresponds to the voxel is removed by rewriting the voxel data of the voxel such that the voxel data indicates the absence of a terrain object.

For example, in the present example, removal/deformation of a voxel is controlled by changing a density included in the voxel data thereof. For example, the density is an index indicating the proportion of the volume of a voxel object to a region defined by a voxel. The density can take an integer value in the range from the lower limit value (e.g., 0) to the upper limit value (e.g., 255). It is assumed that the higher the value of the density set for a voxel, the greater the proportion in the voxel, and the lower the value of the density, the smaller the proportion in the voxel. It is also assumed that no voxel object is included in a voxel the value of the density of which is the lower limit (e.g., 0), and a voxel object is included throughout a voxel the value of the density of which is the upper limit value (e.g., 255). In other words, if the value of the density is greater than the lower limit value, the voxel data indicates the presence of a terrain object, and if the value of the density is the lower limit value, the voxel data indicates the absence of a terrain object. Note that the shape of a voxel mesh generated based on the density does not need to have a volume exactly corresponding to the value of the density.

In the present example, removal/deformation of a voxel is controlled by rewriting the density of the voxel based on the signed distance of the voxel with respect to the SDF representing the destruction range. Specifically, by rewriting and reducing the densities of at least voxels having a negative signed distance, at least a portion of the voxels included in the destruction range are changed to the state in which no terrain object is present. As a first example, by rewriting the densities of voxels having a negative signed distance to the lower limit value, the voxels, which are included in the destruction range, are set to the state in which no terrain object is present, and by maintaining the values of the densities of voxels having a positive signed distance unchanged, the voxels, which are out of the destruction range, are set to the state in which a terrain object is present. As a second example, by rewriting the densities of voxels having a negative signed distance such that the value of the density of the voxel decreases with an increase in the absolute value of the distance, and rewriting the densities of voxels whose absolute value is greater than a predetermined value to the lower limit value, a portion of the voxels, which are included in the destruction range, are set to the state in which no terrain object is present, and by maintaining the values of the densities of voxels having a positive signed distance unchanged, the voxels, which are out of the destruction range, are set to the state in which a terrain object is present. As a third example, by rewriting the densities of voxels having a negative signed distance to the lower limit value, the voxels, which are included in the destruction range, are set to the state in which no terrain object is present, and by rewriting the densities of voxels having a positive signed distance such that the value of the density of the voxel decreases with a decrease in the absolute value of the distance, a portion of the voxels, which are out of the destruction range, are set to the state in which the voxel is not entirely occupied by a voxel object.

Note that when the density in the voxel data is rewritten, the change amount of the density may be adjusted, depending on the type and state of a material indicated by material data included in the voxel data. For example, the change amount of the density may be adjusted (e.g., the change amount of the density to be rewritten is increased for a more breakable material), depending on a property (e.g., breakability or temperature) of a material indicated by the material data.

Alternatively, when the density in the voxel data is rewritten, the change amount of the density may be adjusted, depending on state data included in the voxel data. For example, the state data indicates the amount of damage to the terrain object TO caused by the player character PC. As an example, whether to reduce the density in the voxel data and whether to increase the amount of damage may be determined based on a relationship between the offensive strength of the player character PC and the defensive strength of the terrain object TO. Specifically, based on a relationship between the hardness of the offensive entity (e.g., the hardness of a fist of the player character PC punching the terrain object TO) and the hardness of the defensive (attacked) entity (the hardness of the material of the terrain object TO), the density in the destruction range is rewritten if the hardness of the offensive entity is greater, and neither the density in the destruction range nor the amount of damage is rewritten if the hardness of the defensive (attacked) entity is greater. If the hardness of the offensive entity is substantially equal to the hardness of the defensive (attacked) entity, the amount of damage to voxels in the destruction range is increased, and if the amount of the damage exceeds the acceptable amount of the voxel (the damage endurance value of the material), the densities of the voxels are rewritten. Note that the amount of damage to a voxel exceeds the acceptable amount of the voxel, the density of the voxel may be set to zero, e.g., the voxel may be removed. Thus, the amount of damage to a voxel can serve as voxel data indicating the absence of a terrain.

After the density is rewritten as described above, a mesh is newly formed on a surface (specifically, a surface that is newly exposed to the outside by breaking) of the terrain object TO to update the display. For example, when an event occurs in which the terrain object TO is broken, a mesh is newly formed by recalculating mesh vertices in a range including voxels whose voxel data has been rewritten due to the destruction. As an example, as shown in FIG. 14, mesh vertices are generated. Thus, after voxels are removed, a new mesh is generated between a voxel in which a terrain object is absent and a voxel in which a terrain object is present, by an algorithm that recalculates mesh vertices based on the densities of voxels. Thereafter, texture for use in rendering each face of the mesh is determined based on the voxel data, and the determined texture is mapped to each face, whereby an image of the broken terrain object TO is generated. Note that the range in which mesh recalculation is performed may be a chunk including voxels whose voxel data has been rewritten (a process unit including a predetermined number of voxels). For example, if a chunk includes 16×16×16 voxels, and recalculation is performed on chunks including voxels whose voxel data has been rewritten, processing can be reduced compared to when a mesh is recalculated throughout the game space. The range may be a voxel space in which voxels whose voxel data has been rewritten are located, or the entire terrain object TO, which includes voxels whose voxel data has been rewritten. If the processing load is not so great, a mesh may be recalculated throughout the game space.

In the foregoing, as an example of an event in which the terrain object TO is removed, a portion of the terrain object TO is broken and deformed or removed due to the player character PC's breaking action hitting the terrain object TO, e.g., the player character PC punching the terrain object TO. Alternatively, the terrain object TO may be removed due to other events. For example, in an event, the terrain object TO may be broken by being hit by the entire body or another part such as a leg of the player character PC, or by being hit by the player character PC with an item such as a weapon. Alternatively, in an event, the terrain object TO may be broken by being hit by another object thrown or kicked by the player character PC, or by being hit by a bullet object fired or launched by the player character PC, or the like. The terrain object TO may be removed (deformed) due to such events. The terrain object TO may also be removed (deformed) due to environmental changes or the like in the game space such as application of vibrations caused by an earthquake, or crushing power caused by striking wavefront or wind and rain, deterioration caused by exposure to outdoor air, or decomposition, independently of the player character PC's action.

In the foregoing, the terrain object TO is used as an example of an object that is partially removed from the game space. Other voxel objects may, of course, be removed from the game space by a similar process. For example, other voxel objects such as buildings and trees provided in the game space, moving bodies such as vehicles moving in the game space, other characters such as opponent characters present in the game space, items provided in the game space, objects such as foods and tools provided in the game space, may be subjected to a similar process of removing a portion thereof from the game space.

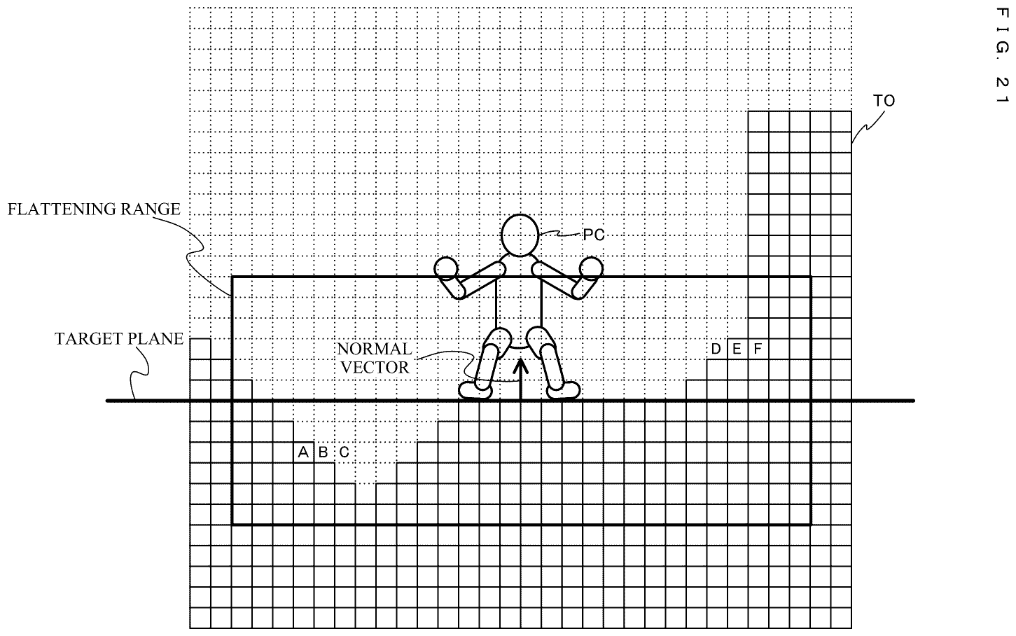

FIG. 21 is a diagram showing an example of a flattening range of voxels in a terrain object TO to be subjected to the flattening process, and a target plane that is a target of the flattening process, which depend on a flattening action. Note that in FIG. 21, solid-line blocks represent voxels having such a density that the voxels are regarded as being included in the terrain object TO, and dashed-line blocks represent voxels having such a density that the voxels are regarded as being excluded from the terrain object TO. Although FIG. 21 shows an example of a cross-section of the terrain object TO rendered by a block-shaped mesh for the sake of convenience, the terrain object TO may be rendered by generation of a mesh having an appearance as shown in FIG. 15 using the technique described with reference to FIG. 14.

The flattening range of the terrain object TO to be flattened by the player character PC's flattening action is set based on a location where the player character PC performs a flattening action on the terrain object TO. For example, the flattening range is set in a range such that a horizontal distance from a reference location set based on a location where the player character PC has performed a flattening action in the game space is within a first distance, and a distance from a plane including the reference location is within a second distance. In the example of FIG. 21, for the terrain object TO, a flattening range in the shape of a cylinder having a radius that is equal to the first distance and a height that is two times the second distance, and a cylinder axis is vertical in the game space, is formed around the reference location where the player character PC has performed a flattening action. Note that the shape of the flattening range may be other shapes such as a cube, polygonal prism, sphere, ellipsoid, cone, pyramid, wedge, shapes generated by 3D software, and in addition, these shapes a portion of which has been removed, and the like. The flattening range may be set around a location where the player character PC has performed a flattening action (e.g., a location where the player character PC's has slapped the terrain object TO) in the game space, or around a location where the player character PC is present when having performed a flattening action. A size of the flattening range may be set based on the strength of the player character PC's flattening action, an ability of the player character PC, the strength (material) of the terrain object TO, or the like.

The target plane that is a target for flattening by the player character PC's flattening action is set based on a location where the player character PC is present when having performed a flattening action. For example, the target plane is set to a horizontal plane in the game space that includes a location where the player character PC is present when having performed a flattening action. Note that the location of the target plane may be set to a horizontal plane including a location where the player character PC has performed a flattening action in the game space (e.g., a location where the player character PC has slapped the terrain object TO), or a horizontal plane including another location on a ground in the flattening range.

In the flattening process of the present example, a surface shape of the terrain object TO is flattened by changing the densities of voxels included in the flattening range according to the player character PC's flattening action such that the surface shape of the terrain object TO approaches the target plane. Specifically, for each voxel included in the flattening range, the density of the voxel is changed based on whether the voxel is located above or below the target plane, whether or not the density of the voxel is greater than or equal to a reference value, and whether or not the density of a voxel adjacent to that voxel in the direction of a normal to the target plane is greater than or equal to a reference value. Note that the flattening range may be represented by an SDF. In the case in which the flattening range is represented by an SDF, it may be determined whether or not each voxel is in the flattening range, based on a signed distance between the voxel and a surface of the flattening range closest to the voxel.

An expansion process of raising a ground surface is performed on a voxel(s) below the target plane. For example, the density of a voxel below the target plane that has a density greater than or equal to a reference value (e.g., the reference value=128) (e.g., a voxel having such a density that the voxel is regarded as being included in the terrain object TO) is increased by a predetermined value (a voxel A in FIG. 21). The density of a voxel below the target plane that has a density smaller than the reference value (e.g., a voxel having such a density that the voxel is regarded as being excluded from the terrain object TO) is increased by a predetermined value if the density of a voxel adjacent to that voxel in a downward direction in the game space that is opposite to the direction of a normal vector to the target plane is greater than or equal to the reference value (a voxel B in FIG. 21), and is not changed if the density of the adjacent voxel is smaller than the reference value (a voxel C in FIG. 21). Note that the direction of a normal vector to the target plane is a direction perpendicular to the target plane and toward the outside from the inside of the terrain object TO, and is here an upward direction in the game space.

A shrinkage process of lowering a ground surface is performed on a voxel(s) above the target plane. For example, the density of a voxel above the target plane that has a density smaller than a reference value is decreased by a predetermined value (a voxel D in FIG. 21). The density of a voxel above the target plane that has a density greater than or equal to the reference value is decreased by a predetermined value if the density of a voxel adjacent to that voxel in an upward direction in the game space that is the direction of a normal vector to the target plane is smaller than the reference value (a voxel E in FIG. 21), and is not changed if the density of the adjacent voxel is greater than or equal to the reference value (a voxel F in FIG. 21).

After the density is changed by a predetermined amount as described above, a mesh is newly formed on a surface (specifically, a flattened ground surface) of the terrain object TO to update the display. For example, when an event occurs in which the terrain object TO is flattened, a mesh is newly formed by recalculating mesh vertices in a range including at least voxels whose voxel data has been rewritten due to the flattening. As an example, as shown in FIG. 14, mesh vertices are generated. Thus, after the flattening process, a new mesh is generated between a voxel in which a terrain is absence and a voxel in which a terrain is present, according to an algorithm that recalculates mesh vertices based on the densities of voxels. Thereafter, texture for use in rendering each face of the mesh is determined based on the voxel data, and the determined texture is mapped to each face, whereby an image of the flattened terrain object TO is generated. Note that the range in which mesh recalculation is executed may be set in the flattening process in a manner similar to that of the destruction process.

Note that the flattening action may cause a mesh in a range including flattened voxels to shake at a predetermined frequency for a predetermined period of time, e.g., may change the locations of vertices of the mesh at the frequency for the period of time. By changing the locations of vertices of the mesh for a period of time that includes at least a time when a process of rewriting voxel data is performed due to the above flattening process, and which is triggered by a flattening action, a terrain surface at a flattened portion of the terrain object TO appears to shake, so that changes in a terrain due to flattening can be prevented from seeming unnatural to the user.

Thus, by changing the densities of voxels included in the flattening range, the terrain object TO in the flattening range can be flattened to approach the target plane. An amount (flattening strength) by which the terrain object TO is deformed when the flattening process is executed once can be adjusted by the predetermined value by which the density is changed. Even in the case in which the flattening strength is relatively small, a plane close to the target plane can be formed around the location of the player character PC by performing the flattening process a plurality of times. If the above density change is used, only a ground portion of the terrain object TO can be flattened, so that a terrain feature of the terrain object TO such as a wall, gap, or cliff can be prevented from disappearing.

Note that the flattening process may be executed once or several times when a flattening action is performed once.

The predetermined amount by which the density of a voxel is changed due to the flattening process may be changed based on the location of the voxel in the flattening range. For example, the predetermined amount by which the density is changed with reference to the flattening range may be set using an SDF. For example, a signed distance from a center of the flattening range or a signed distance to a surface of the flattening range may be set for a voxel in the flattening range, and the predetermined amount by which the density is changed may be changed, depending on the signed distance of the voxel. For example, the predetermined amount by which the density of a voxel is changed may be increased as the voxel is closer to the location of the flattening action or the location of the player character PC, and may be decreased as the voxel is closer to an edge of the flattening range. In that case, a scene may be provided in which a ground portion approaches the target plane more quickly as the ground portion is closer to the location of the flattening action or the location of the player character PC.

Note that the predetermined amount by which the density is changed due to the flattening process may be adjusted, depending on the type and state of a material indicated by material data included in the voxel data. For example, the predetermined amount may be adjusted, depending on a property (e.g., breakability or temperature) of a material indicated by the material data (e.g., the predetermined amount is increased for a more breakable material). A voxel for which the predetermined amount is zero and which therefore cannot be flattened (e.g., for an unbreakable material, the predetermined amount is zero, and the density thereof is not changed) may be included in the flattening range, depending on a property of a material indicated by the material data. The predetermined amount by which the density is changed due to the flattening process may also be adjusted, depending on the strength of a flattening action performed by the player character PC, an ability of the player character PC, or the like.

Note that in the case in which a plurality of materials are blended together in a single voxel, the density of only a material(s) broken may be changed. As an example, when a voxel in which an unbreakable material and a breakable material are blended together at a density of 155 and 100, respectively, is subjected to a process of reducing the density by 200, the voxel may be changed to one in which only the density of the breakable material is reduced, so that the density of the unbreakable material is 155 and the density of the breakable material is 0 (e.g., the breakable material is absent).

The predetermined amount by which the density is changed due to the flattening process may also be adjusted, depending on state data included in the voxel data. For example, the state data indicates the amount of damage to the terrain object TO caused by the player character PC. As an example, whether to change the density in the voxel data by the predetermined amount according to a flattening action and whether to increase the amount of damage according to a flattening action may be determined based on a relationship between the offensive strength of the player character PC and the defensive strength of the terrain object TO. Specifically, based on a relationship between the strength of the offensive entity (e.g., the strength of flattening of the terrain object TO by the player character PC) and the strength of the defensive (attacked) entity (the hardness of the material of the terrain object TO), the density in the flattening range is changed by a predetermined amount if the strength of the offensive entity is greater, and neither the density nor the amount of damage in the flattening range is rewritten if the strength of the defensive (attacked) entity is greater. If the strength of the offensive entity is substantially equal to the strength of the defensive (attacked) entity, the amount of damage to a voxel in the flattening range is increased, and if the amount of damage exceeds the acceptable amount of the voxel (the damage endurance value of the material), the density of the voxel is rewritten.

In the foregoing, an example has been described in which as an example of an event in which the terrain object TO is flattened, the player character PC performs a flattening action such as slapping or jumping and landing on the terrain object TO on a ground portion of the terrain object TO. The terrain object TO may be flattened by other events. For example, in an event, the terrain object TO may be flattened by being hit by the entire body or another part such as a hand or foot of the player character PC, or by being hit by the player character PC with an item such as a weapon. In another event, the terrain object TO may be flattened by being hit by another object thrown or kicked by the player character PC, or by being hit by a bullet object fired or launched by the player character PC, or the like. The terrain object TO may also be flattened due to environmental changes or the like in the game space such as application of vibrations caused by an earthquake, or crushing power caused by striking wavefront or wind and rain, deterioration caused by exposure to outdoor air, or decomposition, independently of the player character PC's action.

In the foregoing, the terrain object TO is used as an example of an object that is partially flattened. Even in the case in which other voxel objects are flattened, a similar process may, of course, be performed. For example, even other voxel objects such as buildings and trees provided in the game space, moving bodies such as vehicles moving in the game space, other characters such as opponent characters present in the game space, items provided in the game space, and objects such as foods and tools provided in the game space, may be similarly partially flattened by a similar process.

In the foregoing, the flattening range is in the shape of a cylinder whose cylinder axis is vertical in the game space (e.g., the upper and lower surfaces of the cylinder are horizontal), and the target plane is a horizontal plane in the game space. Alternatively, the flattening range and/or the target plane may have other orientations.

In a first example, the terrain object TO may have a wall surface, and when a flattening action is performed on the wall surface, the flattening process may be executed, in which a vertical surface in the game space that includes a location where the player character PC is in contact with the wall surface is a target plane. In that case, the flattening range may be set to a cylindrical shape whose cylinder axis is horizontal in the game space with reference to a location where the flattening action has been performed (e.g., the upper and lower surfaces of the cylindrical shape are vertical).

In a second example, a surface sloped with respect to a horizontal plane in the game space may be a target plane, depending on a slope of a ground on which the player character PC is located or the average slope of a ground in the flattening range. In that case, the direction of a normal vector to the target plane is different from the vertical and horizontal directions of the game space. Therefore, a plurality of voxels adjacent to a voxel whose density is to be changed in the direction of the normal vector or in a direction opposite to the direction of the normal vector may be selected. For example, in the case in which a plurality of voxels adjacent to a voxel whose density is to be changed in the direction of the normal vector are selected, a voxel closest to the voxel whose density is to be changed in the direction of the normal vector, and at least one voxel (e.g., a second-closest voxel in the direction of the normal vector) selected from eight voxels adjacent to that voxel, excluding the voxel whose density is to be changed, are selected. Thereafter, the expansion process or the shrinkage process is executed using a density calculated by interpolating between the densities of the selected adjacent vectors, as the density of adjacent voxels. In the interpolation, the average value of densities, the greatest value of densities, the smallest value of densities, or the like may be calculated. Note that the flattening range of the second example may be set and sloped in the game space such that the upper and lower surface of the cylinder shape are parallel to the target plane, or are horizontal in the game space.

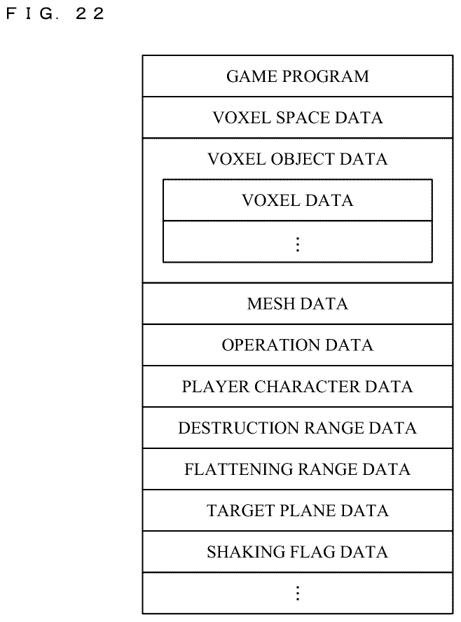

Next, a specific example of an information process of the game system 1 will be described with reference to FIGS. 22 to 25.

FIG. 22 is a diagram showing an example of various kinds of data used in an information process executed in the game system 1. As shown in FIG. 22, the game system 1 stores a game program, voxel space data, voxel object data, mesh data, operation data, player character data, destruction range data, flattening range data, target plane data, shaking flag data, and the like. The game program and the voxel space data are previously stored in the game system 1 before a game process is executed. The game program and the voxel space data are, for example, stored in a storage medium attached to the slot 23 of the main body apparatus 2. The voxel object data, mesh data, operation data, player character data, destruction range data, flattening range data, target plane data, and shaking flag data are generated during execution of a game process. The voxel object data, mesh data, operation data, player character data, destruction range data, flattening range data, target plane data, and shaking flag data are, for example, stored into the DRAM 85 of the main body apparatus 2.

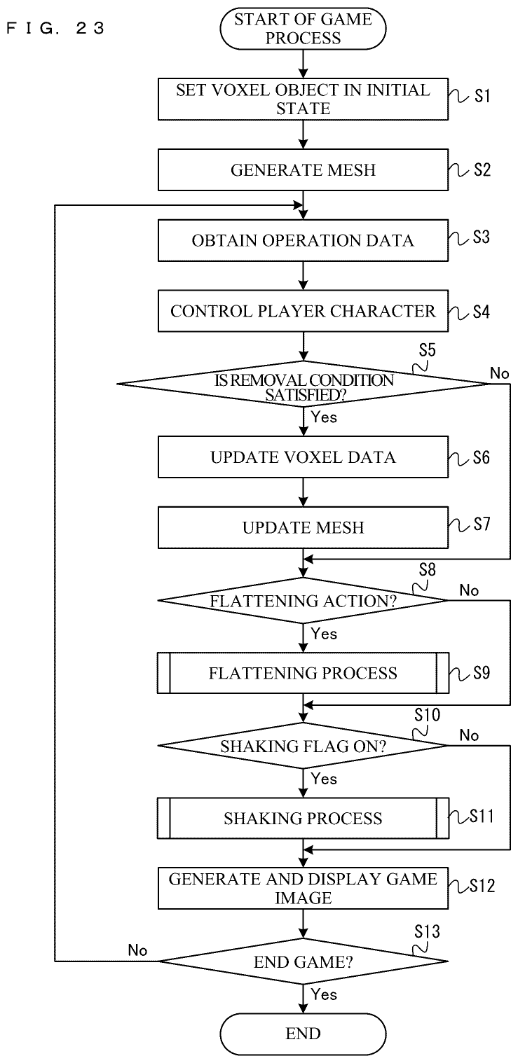

The game program is for executing a game process (specifically, the game process shown in FIGS. 23 to 25) of the present example.

The voxel space data specifies voxels that are set in the game space. Specifically, the voxel space data indicates the length of an edge of each voxel, and the orientation of each edge of the voxel in the game space. In the case in which voxels are set only in part of the game space, the voxel space data includes data indicating the location and size of a space in which voxels are set (e.g., a voxel space) (e.g., data indicating a range of the game space in which voxels are set).

The voxel object data indicates a voxel object that is provided in the game space. Specifically, the voxel object data includes voxel data for each unit region in all or part of the game space.

The mesh data indicates a mesh that is set for a voxel object which is provided in the game space. The mesh data includes, for example, data indicating the vertices of a mesh.

The operation data is obtained, as appropriate, from each of the left controller 3 and/or the right controller 4 and the main body apparatus 2. As described above, the operation data obtained from each of the left controller 3 and/or the right controller 4 and the main body apparatus 2 includes information about an input from each input section (specifically, each button, an analog stick, or a touch panel) (specifically, information about an operation). In the present example, operation data is obtained from each of the left controller 3 and/or the right controller 4 and the main body apparatus 2. The obtained operation data is used to update the operation data as appropriate. Note that the operation data may be updated for each frame that is the cycle of a process (to be described below) executed in the game system 1, or may be updated each time operation data is obtained.

The player character data indicates the place and position of the player character PC placed in the virtual space, the movement and state in the virtual space of the player character PC, and the like.

The destruction range data indicates a destruction range that is set when a terrain object TO is broken by the player character PC.

The flattening range data indicates a flattening range that is set when a terrain object TO is flattened by the player character PC.

The target plane data indicates a target plane that is set when the player character PC has broken a terrain object TO and a normal vector to the target plane.

The shaking flag data indicates whether or not a shaking flag is on.

Note that in addition to the data shown in FIG. 22, the game system 1 stores, for example, data of the above property information and texture information as data that is previously stored in the game system 1 before a game process is executed.

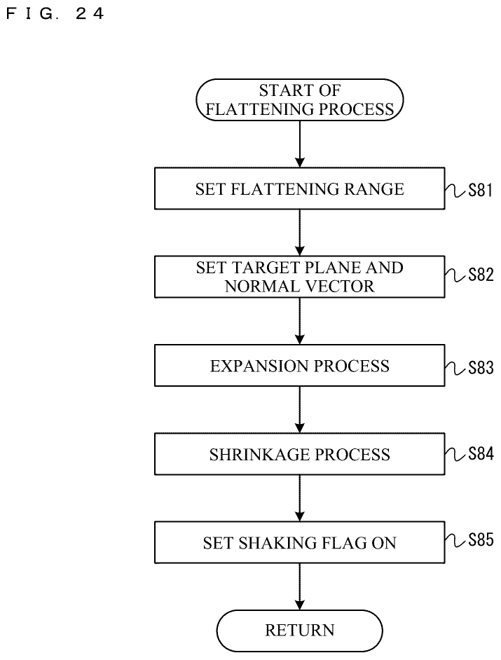

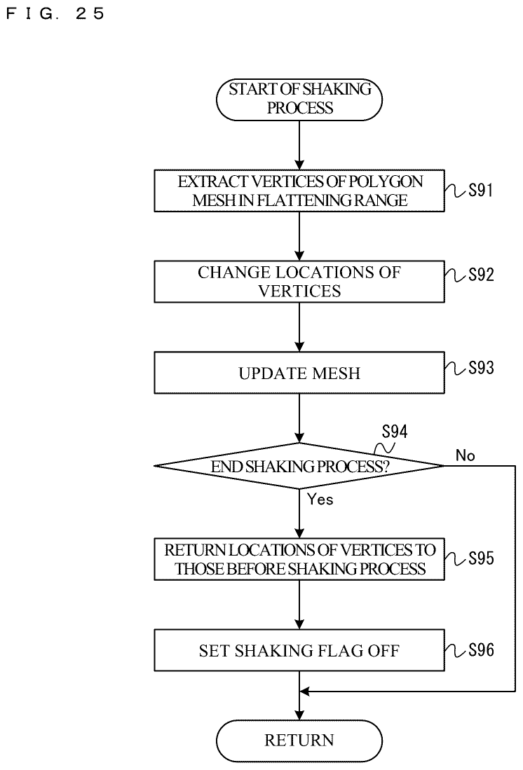

FIG. 23 is a flowchart showing an example of a flow of a game process that is executed in the game system 1. FIG. 24 is a subroutine showing an example of a flattening process of step S9 in the flowchart of FIG. 23. FIG. 25 is a subroutine showing an example of a shaking process of step S11 in the flowchart of FIG. 23. In the present example, a series of steps shown in FIGS. 23 to 25 are executed by the processor 81 executing the game program. The game process of FIGS. 23 to 25 is started with any suitable timing. As an example, the game process of FIG. 21 is started according to an instruction to start a game that is provided by a player during execution of the game program.

Note that in the present embodiment, it is assumed that the processor 81 of the main body apparatus 2 executes the game program stored in the game system 1 to execute each step of FIGS. 23 to 25. Note that in another exemplary embodiment, a portion of the steps may be executed by a processor (e.g., a dedicated circuit) other than the processor 81. In the case in which the game system 1 can communicate with another information processing device (e.g., a server), a portion of the steps of FIGS. 23 to 25 may be executed by the information processing device. In other words, the steps of FIGS. 23 to 25 may be executed by a plurality of information processing devices including the main body apparatus 2 working together. The steps of FIGS. 23 to 25, which are merely for illustrative purposes, may be executed in a different order, or another step may be executed in addition to (or instead of) each step, if a similar effect is obtained.

The processor 81 executes the steps of FIGS. 23 to 25 using a memory (e.g., the DRAM 85). Specifically, the processor 81 stores information (in other words, data) obtained in each process step into a memory, and reads and uses the information from the memory when the information is required in a subsequent process step.

In FIG. 23, the processor 81 sets a voxel object in an initial state in the game space (step S1), and proceeds to the next step. Specifically, the processor 81 obtains voxel data indicating the arrangement of a voxel object in an initial state, and stores (in other words, writes) all or a portion of the obtained voxel data as the voxel object data into the DRAM 85. Note that the voxel data indicating the arrangement of a voxel object in an initial state is, for example, stored in a storage medium attached to the slot 23 of the main body apparatus 2. Note that a computer that stores, into a storage medium, volume data holding voxel data for each voxel included in a voxel space in a virtual space, the voxel data including at least a density indicating a degree to which a space defined by the voxel is occupied by an object, and thereby representing a shape of a terrain in the virtual space, corresponds to the processor 81 executing step S1, for example.

Note that voxel data that is written as the voxel object data into the DRAM 85 may be voxel data corresponding to a partial range that is used in generation of a game image, of the voxel data corresponding to the entire range of the game space. For example, the processor 81 may generate an image of an object using voxel data corresponding to only a partial range of the game space (e.g., a range within a predetermined distance from the location of a virtual camera). In that case, the voxel object data may include voxel data within that range. When voxel data corresponding to a partial range of the game space is written, a process similar to step S1 is executed with appropriate timing (e.g., at a timing when the location of the virtual camera is moved by at least a predetermined distance) during execution of steps S3 to S13 to be described below.

Next, the processor 81 generates a mesh for the voxel object (step S2), and proceeds to the next step, in which the processor 81 starts a game, and repeatedly executes steps S3 to S13 in the game. A mesh is generated by the above method. Here, the processor 81 generates a mesh based on the voxel object data stored in the DRAM 85. As a result of step S2, a voxel object such as a terrain object is constructed in the game space.

Next, the processor 81 obtains data corresponding to the user's operation from the left controller 3, the right controller 4, and/or the main body apparatus 2, updates the operation data (step S3), and proceeds to the next step.

Next, the processor 81 controls actions of various objects appearing in the game space (e.g., a player character and an opponent character) (step S4), and proceeds to the next step. For example, the processor 81 controls the player character's action based on the operation data obtained in step S3, and updates the player character data. The processor 81 also controls an opponent character's action based on an algorithm specified in the game program. Note that a computer that moves a player character on a terrain according to a user's operation input corresponds to the processor 81 performing step S4, for example.

Next, the processor 81 determines whether or not a removal condition for removal of at least a portion of the voxel object is satisfied (step S5). For example, if the player character PC has hit the terrain object TO by a breaking action, the processor 81 sets a location where the terrain object TO has been hit and a surrounding range as a destruction range, updates the destruction range data, breaks the terrain object TO (voxel object) present within the destruction range, and removes the broken portion. As an example, in order to represent a state that the destruction range has been broken, the densities indicated by the voxel data of at least a portion of the voxels included in the destruction range are set to zero, whereby the object in the destruction range is removed. Therefore, if a voxel(s) of the voxel object is included in the destruction range hit by the player character, the result of the determination by the processor 81 is step S5 is positive. If the removal condition is satisfied, the processor 81 proceeds to step S6. Otherwise, i.e., if the removal condition is not satisfied, the processor 81 proceeds to step S8.

In step S6, the processor 81 updates the voxel data related to the voxel object that satisfies the removal condition, and proceeds to the next step. For example, in order to remove at least a portion of the voxel object that satisfies the removal condition, the processor 81 changes the densities of voxels in a portion hit by the player character and a surrounding portion, and updates the voxel data corresponding to each voxel. The processor 81 reduces the densities of voxels around the destruction range to be removed (e.g., the hit range) (provided that the reduced density is greater than or equal to zero), and thereby deforms the voxel object in the voxels around the destruction range. Specifically, the processor 81 updates the voxel object data stored in the DRAM 85 such that the density data is changed for the voxel data of the voxels in the range to be removed and a surrounding portion. Note that the processor 81 may update the density data such that the density indicates a value smaller than the reference value. For example, the processor 81 may set the densities of voxels in a portion (destruction range) hit by the player character to zero, and may reduce the densities of voxels in a surrounding region by a predetermined value.

Next, in step S7, the processor 81 updates the mesh for the voxel object whose voxel data has been changed in step S6, and proceeds to the next step. Specifically, the processor 81 generates a mesh for the voxel object that satisfies the removal condition, based on the voxel object data updated in step S6. Thus, a mesh for a terrain object can be dynamically changed in a game. Note that the processor 81 updates the mesh data stored in in the DRAM 85 such that the mesh data indicates the newly generated mesh. Note that a computer that causes a player character to perform a breaking action of breaking a terrain according to a first instruction based on an operation input, and when the breaking action hits the terrain, updates voxel data such that a density of a voxel included in a first range set at a location based on a location of the player character indicates the absence of a terrain, corresponds to the processor 81 performing steps S6 and S7, for example. A computer that generates a polygon mesh between a voxel defined in a terrain and a voxel defined out of the terrain, based on a density, according to an algorithm for determining locations of vertices of a polygon based on voxel data, and recalculates vertices of the polygon mesh in a range including at least a voxel whose voxel data has been updated, based on occurrence of a breaking action or a flattening action, corresponds to the processor 81 performing step S7, for example.

Next, the processor 81 determines whether or not the player character has performed a flattening action (step S8). If a flattening action has been performed, the processor 81 proceeds to step S9. Otherwise, i.e., if a flattening action has not been performed, the processor 81 proceeds to step S10.

In step S9, the processor 81 executes the flattening process, and proceeds to step S10. The flattening process performed in step S9 will be described with reference to FIG. 24 below. Note that a computer that causes a player character to perform a flattening action of flattening a terrain according to a second instruction based on an operation input, and updates a density in voxel data of a voxel included in a second range set at a location based on a location of the player character, according to the flattening action, such that a surface shape of the terrain approaches a plane set based on the location of the player character, corresponds to the processor 81 performing step S9, for example.

In FIG. 24, the processor 81 sets a flattening range (step S81), and proceeds to the next step. For example, the flattening range is generated with reference to a reference location based on a location where a flattening action has been performed according to the above method, and the processor 81 updates the flattening range data stored in the DRAM 85 such that the flattening range data indicates the newly generated flattening range.

Next, the processor 81 sets a target plane and a normal vector (step S82), and proceeds to the next step. For example, a target plane and a vector normal to the target plane are generated based on a location of the player character PC according to the above method, and the processor 81 updates the target plane data stored in the DRAM 85 such that the target plane data indicates the newly generated target plane and normal vector.

Next, the processor 81 executes the expansion process of raising a ground surface for a voxel located blow the target plane set in step S82 (step S83), and proceeds to the next step. For example, the processor 81 increases the density of a voxel whose density is greater than or equal to a reference value, and decreases the density of a voxel whose density is smaller than the reference value, based on the density of an adjacent voxel in a direction opposite to the normal vector, according to the above method. Thereafter, the processor 81 updates the voxel data stored in the DRAM 85 such that the voxel data indicates the changed density. The processor 81 also updates the mesh of the voxel object whose voxel data has been updated, based on the voxel data, and updates the mesh data stored in the DRAM 85 such that the mesh data indicates the newly generated mesh.

Next, in step S84, the processor 81 executes the shrinkage process of lowering a ground surface, on a voxel located above the target plane set in step S82, and proceeds to the next step. For example, the processor 81 decreases the density of a voxel whose density is smaller than a reference value, and decreases the density of a voxel whose density is greater than or equal to the reference value, based on the density of an adjacent voxel in the direction of the normal vector, according to the above method. Thereafter, the processor 81 updates the voxel data stored in the DRAM 85 such that the voxel data indicates the changed density. The processor 81 also updates the mesh of the voxel object whose voxel data has been updated, based on the voxel data, and updates the mesh data stored in the DRAM 85 such that the mesh data indicates the newly generated mesh. Note that a computer that generates a polygon mesh between a voxel defined in a terrain and a voxel defined out of a terrain, based on a density, according to an algorithm for determining locations of vertices of a polygon based on voxel data, and recalculates vertices of the polygon mesh in a range including at least a voxel whose voxel data has been updated, based on occurrence of a breaking action or a flattening action, corresponds to the processor 81 performing steps S83 and S84, for example.

Next, the processor 81 sets the shaking flag on (step S85), and ends the subroutine. For example, the processor 81 sets ‘on’ the shaking flag indicated by the shaking flag data stored in the DRAM 85, and updates the shaking flag data.

Note that the flattening process of steps S81 to S85 may be executed a plurality of times when a flattening action is performed once. In that case, in step S8, the positive result of the determination may be obtained a plurality of times before the negative result of the determination is obtained.

Referring back to FIG. 23, in step S10, the processor 81 determines whether or not the shaking flag is on, based on the shaking flag data stored in the DRAM 85. If the shaking flag is on, the processor 81 proceeds to step S11. Otherwise, i.e., if the shaking flag is off, the processor 81 proceeds to step S12.

In step S11, the processor 81 executes the shaking process, and proceeds to step S12. The shaking process of step S11 will be described with reference to FIG. 25. Note that in a game, step S12 is repeatedly executed at a rate of once per predetermined time (e.g., one frame time). Note that a computer that displays a scene that a surface of a terrain is shaken by changing locations of vertices of a polygon mesh for a predetermined period of time, according to a flattening action, corresponds to the processor 81 performing step S11, for example.

In FIG. 25, in step S91, the processor 81 extracts vertices of the polygon mesh in the flattening range that have been moved due to the flattening process of step S9, and proceeds to the next step. For example, from the vertices of the polygon mesh located in the flattening range indicated by the flattening range data, the processor 81 extracts vertices of the polygon mesh that have been moved due to the flattening process of step S9, based on the mesh data stored in the DRAM 85.

Next, the processor 81 changes the mesh vertices extracted in step S91, according to a predetermined algorithm (step S92), and proceeds to the next step. For example, the processor 81 changes the locations of the mesh vertices using an algorithm for providing a scene that a mesh is shaken, and updates the mesh data stored in the DRAM 85 using the changed locations.

Next, in step S93, the processor 81 updates the mesh using the locations of the mesh vertices changed in step S92, and proceeds to the next step. Specifically, the processor 81 generates a mesh using the vertex locations changed in step S92. Thus, a mesh for a terrain object can be dynamically changed so as to shake. Note that the processor 81 updates the mesh data stored in the DRAM 85 such that the mesh data indicates the newly generated mesh.

Next, the processor 81 determines whether or not to end the shaking process (step S94). For example, a period of time during which the shaking process is executed is previously determined, and when the period of time has passed, the processor 81 determines to end the shaking process in step S94. If the processor 81 determines to end the shaking process, the processor 81 proceeds to step S95. Meanwhile, if the processor 81 determines to continue the shaking process, the processor 81 ends the subroutine.

In step S95, the processor 81 returns the locations of the mesh vertices changed in step S92 to those before the shaking process, and proceeds to the next step. For example, the processor 81 returns the locations of the mesh vertices changed in step S92 to the former locations of the mesh vertices, and updates the mesh data stored in the DRAM 85 using the former locations of the mesh vertices.

Next, the processor 81 sets the shaking flag off (step S96), and ends the subroutine. For example, the processor 81 sets ‘off’ the shaking flag indicated by the shaking flag data stored in the DRAM 85, and updates the shaking flag data.

Referring back to FIG. 23, in step S12, the processor 81 generates and displays a game image of the game space on a display device, and proceeds to the next step. Specifically, the processor 81 generates a game image of the game space including the voxel object and other objects (e.g., a player character and an opponent character). Note that an image of a voxel object is generated by the above method using the voxel object data and the mesh data stored in the DRAM 85. An image of a player character is generated using the player character data stored in the DRAM 85. Thereafter, the processor 81 displays the generated game image on a display device. Note that in a game, step S12 is repeatedly executed at a rate of once per predetermined time (e.g., one frame time). Note that a computer that generates an image of a virtual space by rendering at least a polygon mesh representing a surface of a terrain, based on volume data, corresponds to the processor 81 executing step S12, for example.

Next, the processor 81 determines whether or not to end the game (step S13). In step S13, the game process is ended, for example, if a condition for ending the game process is satisfied, the user has performed an operation of ending the game process, or the like. If the processor 81 does not determine to end the game process, the processor 81 returns to step S3, and repeats the process. Otherwise, i.e., if the processor 81 determines to end the game process, the processor 81 ends the flowchart. Following this, steps S3 to S13 are repeated executed until the processor 81 determines to end the game process in step S13.

Thus, in the present example, a terrain object generated from voxels can be freely broken according to the user's operation, and a terrain around a player character can be flattened and regraded, and can be deformed with a high degree of freedom in a game.

The game system 1 may be any suitable apparatus, including a handheld game apparatus, or any suitable handheld electronic apparatus (a personal digital assistant (PDA), mobile telephone, personal computer, camera, tablet computer, etc.), etc. In that case, an input apparatus for performing an operation of causing a player object PC to perform an action may be, instead of the left controller 3 or the right controller 4, another controller, mouse, touchpad, touch panel, trackball, keyboard, directional pad, slidepad, etc.

In the foregoing, the information processes are performed in the game system 1. Alternatively, at least a portion of the process steps may be performed in another apparatus. For example, when the game system 1 can also communicate with another apparatus (e.g., another server, another information processing apparatus, another image display apparatus, another game apparatus, another mobile terminal, etc.), the process steps may be executed in cooperation with the second apparatus. By thus causing another apparatus to perform a portion of the process steps, a process similar to the above process can be performed. The above information process may be executed by a single processor or a plurality of cooperating processors included in an information processing system including at least one information processing apparatus. In the above non-limiting example, the information processes can be performed by the processor 81 of the game system 1 executing predetermined programs. Alternatively, all or a portion of the above processes may be performed by a dedicated circuit included in the game system 1.

Here, according to the above non-limiting variation, the present example can be implanted in a so-called cloud computing system form or distributed wide-area and local-area network system forms. For example, in a distributed local-area network system, the above process can be executed by cooperation between a stationary information processing apparatus (a stationary game apparatus) and a mobile information processing apparatus (handheld game apparatus). It should be noted that, in these system forms, each of the above steps may be performed by substantially any of the apparatuses, and the present example may be implemented by assigning the steps to the apparatuses in substantially any manner.

The order of steps, setting values, conditions for determination, etc., used in the above information process are merely illustrative, and of course, other order of steps, setting values, conditions for determination, etc., may be used to implement the present example.

The above programs may be supplied to the game system 1 not only through an external storage medium, such as an external memory, but also through a wired or wireless communication line. The program may be previously stored in a non-volatile storage device in the game system 1. Examples of an information storage medium storing the program include non-volatile memories, and in addition, CD-ROMs, DVDs, optical disc-like storage media similar thereto, and flexible disks, hard disks, magneto-optical disks, and magnetic tapes. The information storage medium storing the program may be a volatile memory storing the program. Such a storage medium may be said as a storage medium that can be read by a computer, etc. (computer-readable storage medium, etc.). For example, the above various functions can be provided by causing a computer, etc., to read and execute programs from these storage media.

While several non-limiting example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present example and common technical knowledge. It should be understood throughout the present specification that expression of a singular form includes the concept of its plurality unless otherwise mentioned. Specifically, articles or adjectives for a singular form (e.g., “a”, “an”, “the”, etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present example pertain. If there is any inconsistency or conflict, the present specification (including the definitions) shall prevail.

As described above, the present example can be used as a game program, game system, game apparatus, and game processing method in which an object generated from voxels can be broken, flattened, and the like by a user's operation, and therefore, can be deformed with a high degree of freedom in a game.

What is claimed is:

1. A non-transitory computer-readable storage medium having stored therein a game program that, when executed, causes one or more processors of an information processing apparatus to execute information processing comprising:
storing, in a storage medium, volume data holding voxel data for each voxel included in a voxel space in a virtual space, the voxel data including at least a density indicating a degree to which a space defined by the voxel is occupied by an object, and thereby representing a shape of a terrain in the virtual space;
moving a player character on the terrain, based on a user's operation input;
causing the player character to perform a breaking action of breaking the terrain according to a first instruction based on the operation input, and when the breaking action hits the terrain, updating the voxel data such that the density of a voxel included in a first range set at a location based on a location of the player character indicates the absence of the terrain;
causing the player character to perform a flattening action of flattening the terrain according to a second instruction based on the operation input, and according to the flattening action, updating the density in the voxel data of a voxel included in a second range set at a location based on the location of the player character such that a surface shape of the terrain approaches a plane set based on the location of the player character; and
generating an image of the virtual space by rendering at least a polygon mesh representing a surface of the terrain, based on the terrain volume data.

2. The non-transitory computer-readable storage medium according to claim 1, wherein
the information processing further comprises:
according to the flattening action,
increasing the density of a voxel that is included on one direction side of the plane and has a density greater than or equal to a reference value, and increasing the density of a voxel whose density is smaller than the reference value, and for which the density of an adjacent voxel adjacent thereto on the one direction side or a density obtained by interpolating between the densities of a plurality of adjacent voxels is greater than or equal to the reference value, and
decreasing the density of a voxel that is included on the other direction side of the plane and has a density smaller than the reference value, and decreasing the density of a voxel whose density is greater than or equal to the reference value, and for which the density of an adjacent voxel adjacent thereto on the other direction side or a density obtained by interpolating between the densities of a plurality of adjacent voxels is smaller than the reference value.

3. The non-transitory computer-readable storage medium according to claim 2, wherein
the one direction is opposite to a direction pointed by a normal vector to the plane, and the other direction is the direction pointed by the normal vector to the plane.

4. The non-transitory computer-readable storage medium according to claim 2, wherein
the one direction is a downward direction with respect to the virtual space, and the other direction is an upward direction with respect to the virtual space.

5. The non-transitory computer-readable storage medium according to claim 1, wherein
the plane is a horizontal plane in the virtual space.

6. The non-transitory computer-readable storage medium according to claim 1, wherein
the plane passes through a location where the player character is in contact with the terrain.

7. The non-transitory computer-readable storage medium according to claim 6, wherein
the plane is sloped according to a slope of the terrain at a location of the player character.

8. The non-transitory computer-readable storage medium according to claim 1, wherein
the information processing further comprises:
displaying a scene that a surface of the terrain is shaken, by changing locations of vertices of the polygon mesh for a period of time, according to the flattening action.

9. The non-transitory computer-readable storage medium according to claim 1, wherein
the voxel data includes data indicating a hardness or property of an object in the space defined by the voxel, and
the information processing further comprises:
updating the density of a voxel that is in the second range and whose hardness or property satisfies a condition, based on the flattening action.

10. The non-transitory computer-readable storage medium according to claim 1, wherein
the information processing further comprises:
generating the polygon mesh between a voxel defined in the terrain and a voxel defined out of the terrain, based on the density, according to an algorithm that determines locations of vertices of a polygon, based on the voxel data; and
recalculating vertices of the polygon mesh in a range including at least a voxel whose voxel data has been updated, based on occurrence of the breaking action or the flattening action.

11. A game system comprising:
a storage medium storing volume data holding voxel data for each voxel included in a voxel space in a virtual space, the voxel data including at least a density indicating a degree to which a space defined by the voxel is occupied by an object, and thereby representing a shape of a terrain in the virtual space; and
one or more processors that are configured to execute information processing comprising:
moving a player character on the terrain, based on a user's operation input,
causing the player character to perform a breaking action of breaking the terrain according to a first instruction based on the operation input, and when the breaking action hits the terrain, updating the voxel data such that the density of a voxel included in a first range set at a location based on a location of the player character indicates the absence of the terrain,
causing the player character to perform a flattening action of flattening the terrain according to a second instruction based on the operation input, and according to the flattening action, updating the density in the voxel data of a voxel included in a second range set at a location based on the location of the player character such that a surface shape of the terrain approaches a plane set based on the location of the player character, and
generating an image of the virtual space by rendering at least a polygon mesh representing a surface of the terrain, based on the terrain volume data.

12. The game system according to claim 11, wherein
the information processing further comprises:
according to the flattening action,
increasing the density of a voxel that is included on one direction side of the plane and has a density greater than or equal to a reference value, and increasing the density of a voxel whose density is smaller than the reference value, and for which the density of an adjacent voxel adjacent thereto on the one direction side or a density obtained by interpolating between the densities of a plurality of adjacent voxels is greater than or equal to the reference value, and
decreasing the density of a voxel that is included on the other direction side of the plane and has a density smaller than the reference value, and decreasing the density of a voxel whose density is greater than or equal to the reference value, and for which the density of an adjacent voxel adjacent thereto on the other direction side or a density obtained by interpolating between the densities of a plurality of adjacent voxels is smaller than the reference value.

13. The game system according to claim 12, wherein
the one direction is opposite to a direction pointed by a normal vector to the plane, and the other direction is the direction pointed by the normal vector to the plane.

14. The game system according to claim 12, wherein
the one direction is a downward direction with respect to the virtual space, and the other direction is an upward direction with respect to the virtual space.

15. The game system according to claim 11, wherein
the plane is a horizontal plane in the virtual space.

16. The game system according to claim 11, wherein
the plane passes through a location where the player character is in contact with the terrain.

17. The game system according to claim 16, wherein
the plane is sloped according to a slope of the terrain at a location of the player character.

18. The game system according to claim 11, wherein
the information processing further comprises:
displaying a scene that a surface of the terrain is shaken, by changing locations of vertices of the polygon mesh for a period of time, according to the flattening action.

19. The game system according to claim 11, wherein
the voxel data includes data indicating a hardness or property of an object in the space defined by the voxel, and
the information processing further comprises:
updating the density of a voxel that is in the second range and whose hardness or property satisfies a condition, based on the flattening action.

20. The game system according to claim 11, wherein
the information processing further comprises:
generating the polygon mesh between a voxel defined in the terrain and a voxel defined out of the terrain, based on the density, according to an algorithm that determines locations of vertices of a polygon, based on the voxel data; and
recalculating vertices of the polygon mesh in a range including at least a voxel whose voxel data has been updated, based on occurrence of the breaking action or the flattening action.

21. A game apparatus comprising:
a storage medium storing volume data holding voxel data for each voxel included in a voxel space in a virtual space, the voxel data including at least a density indicating a degree to which a space defined by the voxel is occupied by an object, and thereby representing a shape of a terrain in the virtual space; and
one or more processors that are configured to execute information processing comprising:
moving a player character on the terrain, based on a user's operation input;
causing the player character to perform a breaking action of breaking the terrain according to a first instruction based on the operation input, and when the breaking action hits the terrain, updating the voxel data such that the density of a voxel included in a first range set at a location based on a location of the player character indicates the absence of the terrain;
causing the player character to perform a flattening action of flattening the terrain according to a second instruction based on the operation input, and according to the flattening action, updating the density in the voxel data of a voxel included in a second range set at a location based on the location of the player character such that a surface shape of the terrain approaches a plane set based on the location of the player character; and
generating an image of the virtual space by rendering at least a polygon mesh representing a surface of the terrain, based on the terrain volume data.

22. The game apparatus according to claim 21, wherein
the information processing further comprises:
according to the flattening action,
increasing the density of a voxel that is included on one direction side of the plane and has a density greater than or equal to a reference value, and increasing the density of a voxel whose density is smaller than the reference value, and for which the density of an adjacent voxel adjacent thereto on the one direction side or a density obtained by interpolating between the densities of a plurality of adjacent voxels is greater than or equal to the reference value, and
decreasing the density of a voxel that is included on the other direction side of the plane and has a density smaller than the reference value, and decreasing the density of a voxel whose density is greater than or equal to the reference value, and for which the density of an adjacent voxel adjacent thereto on the other direction side or a density obtained by interpolating between the densities of a plurality of adjacent voxels is smaller than the reference value.

23. The game apparatus according to claim 21, wherein
the information processing further comprises:
displaying a scene that a surface of the terrain is shaken, by changing locations of vertices of the polygon mesh for a period of time, according to the flattening action.

24. A game processing method performed on an information processing apparatus, the game processing method comprising:
storing, in a storage medium, volume data holding voxel data for each voxel included in a voxel space in a virtual space, the voxel data including at least a density indicating a degree to which a space defined by the voxel is occupied by an object, and thereby representing a shape of a terrain in the virtual space;
moving a player character on the terrain, based on a user's operation input;
causing the player character to perform a breaking action of breaking the terrain according to a first instruction based on the operation input, and when the breaking action hits the terrain, update the voxel data such that the density of a voxel included in a first range set at a location based on a location of the player character indicates the absence of the terrain;
causing the player character to perform a flattening action of flattening the terrain according to a second instruction based on the operation input, and according to the flattening action, update the density in the voxel data of a voxel included in a second range set at a location based on the location of the player character such that a surface shape of the terrain approaches a plane set based on the location of the player character; and
generating an image of the virtual space by rendering at least a polygon mesh representing a surface of the terrain, based on the terrain volume data.

25. The game processing method according to claim 24, wherein
the method causes the information processing apparatus to further execute:
according to the flattening action,
increasing the density of a voxel that is included on one direction side of the plane and has a density greater than or equal to a reference value, and increasing the density of a voxel whose density is smaller than the reference value, and for which the density of an adjacent voxel adjacent thereto on the one direction side or a density obtained by interpolating between the densities of a plurality of adjacent voxels is greater than or equal to the reference value, and
decreasing the density of a voxel that is included on the other direction side of the plane and has a density smaller than the reference value, and decreasing the density of a voxel whose density is greater than or equal to the reference value, and for which the density of an adjacent voxel adjacent thereto on the other direction side or a density obtained by interpolating between the densities of a plurality of adjacent voxels is smaller than the reference value.

26. The game processing method according to claim 24, wherein
the method causes the information processing apparatus to further execute:
displaying a scene that a surface of the terrain is shaken, by changing locations of vertices of the polygon mesh for a period of time, according to the flattening action.
